(19) United States
(12) Patent Application Publication
(10) Pub. No.: US 2016/0202941 A1
(43) Pub. Date: Jul. 14, 2016

(54) TRANSPORT ROUTE PLANNING

(71) Applicant: CAMS SOFTWARE CORPORATION, British Columbia, (CA)

(72) Inventor: Duncan MCLEOD, Surrey (CA)

(73) Assignee: Cams Software Corporation, British Columbia (CA)

(21) Appl. No.: 14/896,794

(22) PCT Filed: Aug. 15, 2014
(86) PCT No.: PCT/CA2014/000626

§ 371 Date: Dec. 8, 2015

(51) Int. Cl. G06F 3/14; G06Q 10/08; G06F 3/0484

(52) U.S. Cl. CPC G06F 3/14; G06F 3/04847; G06Q 10/083

(57) ABSTRACT

A computer-implemented method of facilitating display of information to a user for use in planning transport routes involves causing at least one processor to: receive signals representing first transport information, produce signals for causing a display to display a representation of the first transport information, derive first derived information from the first transport information, receive user input signals defining changes to the first transport information, generate second transport information representing a second set of proposed second transport routes, produce signals for causing the display to display a representation of the second transport information, derive second derived information derived from the second transport information, and produce signals for causing the display to display a representation comparing the first derived information with the second derived information. A computer-implemented method of facilitating transport information generation for route planning is also disclosed. Apparatuses and computer-readable media are also disclosed.

### BACKGROUND OF THE INVENTION

1. Field of Invention

This invention relates to planning transport routes and more particularly to methods, apparatuses and computer readable media for use in planning of transport routes.

2. Description of Related Art

When loads must be delivered from a load source, such as a warehouse, to a destination location, such as a retail or grocery store, routes or trips may be planned for load carriers such as trucks to transport the loads. To facilitate efficient use of these load carriers, the routes may be planned to minimize various properties such as, for example, costs, that are associated with use of the routes. In some cases, a user may use a computer or computers to facilitate planning of the routes.

Such computers will generally plan the routes using the assumption that the load sources are able to and will provide 100% of the loads that are to be picked up. However, often the load sources are able to provide only a portion of a load that is to be picked up at the load source and so the computer planning the routes may be unable to plan the routes in a way that optimizes use of the capacities of the load carriers.

Once the computer plans the routes, a user may make changes to optimize the routes or to take into consideration various factors or constraints that the computer planning the routes was unable to. However, the routes and changes to the routes can be complex and the computer may be unable to display the routes in a way that allows the user to easily understand what each route represents, and/or how changes to the routes affect the routes individually and as a whole.

### SUMMARY OF THE INVENTION

In accordance with one aspect of the invention, there is provided a computer-implemented method of facilitating display of information to a user for use in planning transport routes. The method involves causing at least one processor to receive signals representing first transport information representing a first set of proposed first transport routes, each first transport route having one or more first locations associated therewith. The first transport information includes, for each of the first locations, a first location identifier and associated first feature information and first load information. The first transport routes are represented by respective sets of the first location identifiers. The method also involves causing the at least one processor to produce signals for causing a display to display a representation of the first transport information, and causing the at least one processor to derive and store in memory first derived information derived from at least one of: the first location identifiers, the first feature information, and the first load information. The method further involves causing the at least one processor to receive user input signals representing changes to the first transport information, and causing the at least one processor to generate second transport information representing a second set of proposed second transport routes based on the received user input signals defining the changes to the first transport information, each second transport route having one or more second locations associated therewith. The second transport information includes, for each of the second locations, a second location identifier and associated second feature information and second load information. The second transport routes are represented by respective second sets of the second location identifiers. The method also involves causing the at least one processor to produce signals for causing the display to display a representation of the second transport information, and causing the at least one processor to derive second derived information derived from at least one of: the second location identifiers, the second feature information, and the second load information. The method also involves causing the at least one processor to produce signals for causing the display to display a representation comparing the first derived information with the second derived information.

In accordance with another aspect of the invention, there is provided a computer-implemented method of facilitating transport information generation for route planning. The method involves causing at least one processor to receive signals representing load information representing at least one load to be transported from a load source to at least one location, and causing the at least one processor to receive signals representing first load source information representing a first expected availability of the at least one load at the load source. The method also involves causing the at least one processor to receive signals representing first carrier capacity information representing respective first capacities of one or more load carriers to be used in transporting the at least one load from the load source to the at least one location, and causing the at least one processor to generate first adjusted carrier capacity information based on the first carrier capacity information and the first load source information, the first adjusted carrier capacity information representing respective first adjusted capacities of the one or more load carriers. The method further involves causing the at least one processor to produce signals for use by a route generator in generating transport information representing a set of proposed transport routes to be used for transporting the at least one load from the load source to the at least one location using the one or more load carriers. The signals represent the load information, and carrier information including the first adjusted carrier capacity information.

In accordance with another aspect of the invention, there is provided a computer readable medium having stored thereon codes which, when executed by at least one processor, cause the at least one processor to perform any one of the above methods.

In accordance with another aspect of the invention, there is provided an apparatus for facilitating display of information to a user for use in planning transport routes. The apparatus includes provisions for receiving signals representing first transport information representing a first set of proposed first transport routes, each first transport route having one or more first locations associated therewith. The first transport information includes, for each of the first locations, a first location identifier and associated first feature information and first load information. The first transport routes are represented by respective sets of the first location identifiers. The apparatus also includes provisions for producing signals for causing a display to display a representation of the first transport information, and provisions for deriving and storing in memory first derived information derived from at least one of: the first location identifiers, the first feature information, and the first load information. The apparatus also includes provisions for receiving user input signals representing changes to the first transport information, and provisions for generating second transport information representing a second set of proposed second transport routes based on the received user input signals defining the changes to the first transport information, each second transport route having one or more second locations associated therewith. The second transport information includes, for each of the second locations, a second location identifier and associated second feature information and second load information. The second transport routes are represented by respective second sets of the second location identifiers. The apparatus also includes provisions for producing signals for causing the display to display a representation of the second transport information, and provisions for deriving second derived information derived from at least one of: the second location identifiers, the second feature information, and the second load information. The apparatus further includes provisions for producing signals for causing the display to display a representation comparing the first derived information with the second derived information.

In accordance with another aspect of the invention, there is provided a computer-implemented apparatus for facilitating transport information generation for route planning. The apparatus includes provisions for receiving signals representing load information representing at least one load to be transported from a load source to at least one location, and provisions for receiving signals representing first load source information representing a first expected availability of the at least one load at the load source. The apparatus also includes provisions for receiving signals representing first carrier capacity information representing respective first capacities of one or more load carriers to be used in transporting the at least one load from the load source to the at least one location, and provisions for generating first adjusted carrier capacity information based on the first carrier capacity information and the first load source information, the first adjusted carrier capacity information representing respective first adjusted capacities of the one or more load carriers. The apparatus further includes provisions for producing signals for use by a route generator in generating transport information representing a set of proposed transport routes to be used for transporting the at least one load from the load source to the at least one location using the one or more load carriers, the signals representing: the load information, and carrier information including the first adjusted carrier capacity information.

In accordance with another aspect of the invention, there is provided an apparatus for facilitating display of information to a user for use in planning transport routes. The apparatus includes at least one processor configured to receive signals representing first transport information representing a first set of proposed first transport routes, each first transport route having one or more first locations associated therewith. The first transport information includes, for each of the first locations, a first location identifier and associated first feature information and first load information. The first transport routes are represented by respective sets of the first location identifiers. The apparatus also includes at least one processor configured to produce signals for causing a display to display a representation of the first transport information, and derive and store in memory first derived information derived from at least one of: the first location identifiers, the first feature information, and the first load information. The apparatus also includes at least one processor configured to receive user input signals representing changes to the first transport information, and generate second transport information representing a second set of proposed second transport routes based on the received user input signals defining the changes to the first transport information, each second transport route having one or more second locations associated therewith. The second transport information includes, for each of the second locations, a second location identifier and associated second feature information and second load information. The second transport routes are represented by respective second sets of the second location identifiers. The apparatus also includes at least one processor configured to produce signals for causing the display to display a representation of the second transport information, and derive second derived information derived from at least one of: the second location identifiers, the second feature information, and the second load information. The apparatus also includes at least one processor configured to produce signals for causing the display to display a representation comparing the first derived information with the second derived information.

In accordance with another aspect of the invention, there is provided an apparatus for facilitating transport information generation for route planning. The apparatus includes at least one processor configured to receive signals representing load information representing at least one load to be transported from a load source to at least one location, receive signals representing first load source information representing a first expected availability of the at least one load at the load source, and receive signals representing first carrier capacity information representing respective first capacities of one or more load carriers to be used in transporting the at least one load from the load source to the at least one location. The apparatus also includes at least one processor configured to generate first adjusted carrier capacity information based on the first carrier capacity information and the first load source information, the first adjusted carrier capacity information representing respective first adjusted capacities of the one or more load carriers, and produce signals for use by a route generator in generating transport information representing a set of proposed transport routes to be used for transporting the at least one load from the load source to the at least one location using the one or more load carriers. The signals represent the load information, and carrier information including the first adjusted carrier capacity information.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a schematic view of a system for facilitating planning of transport routes in accordance with one embodiment of the invention;

FIG. 2 is a schematic view of a processor circuit for implementing a server shown in FIG. 1;

FIG. 3 is a schematic view of a processor circuit for implementing a client computer shown in FIG. 1;

FIG. 4 is a representation of an exemplary order record used in the system shown in FIG. 1;

FIG. 5 is a flowchart depicting blocks of code for directing the server shown in FIG. 2 to facilitate transport information generation for route planning;

FIG. 6 is a representation of exemplary load source information used by the server in the system shown in FIG. 1;

FIG. 7 is a representation of a user interface caused by the server to be displayed using the system shown in FIG. 1;

FIG. 8 is a representation of an exemplary carrier capacity record used by the server in the system shown in FIG. 1;

FIG. 9 is a representation of an exemplary adjusted carrier capacity record used by the server in the system shown in FIG. 1;

FIG. 10 is a representation of an exemplary transport route record used by the server in the system shown in FIG. 1;

FIG. 11A is a representation of a first exemplary feature information record used by the server in the system shown in FIG. 1;

FIG. 11B is a representation of a second exemplary feature information record used by the server in the system shown in FIG. 1;

FIG. 12A is a representation of a first exemplary load information record used by the server in the system shown in FIG. 1;

FIG. 12B is a representation of a second exemplary load information record used by the server in the system shown in FIG. 1;

FIG. 12C is a representation of a third exemplary load information record used by the server in the system shown in FIG. 1;

FIG. 13 is a flowchart depicting blocks of code for directing the server shown in FIG. 2 to facilitate display of information to a user for use in planning transport routes;

FIG. 14 is a representation of exemplary derived information used by the server in the system shown in FIG. 1;

FIG. 15 is a representation of a block of code for generating derived information that may be included in the flowchart shown in FIG. 13;

FIG. 16 is a representation of a block of code for generating derived information that may be included in the flowchart shown in FIG. 13;

FIG. 17 is a representation of a block of code for generating derived information that may be included in the flowchart shown in FIG. 13;

FIG. 18 is a flowchart depicting blocks of code for generating derived information that may be included in the flowchart shown in FIG. 13;

FIG. 19 is a representation of a block of code for generating derived information that may be included in the flowchart shown in FIG. 13;

FIG. 20 is a flowchart depicting blocks of code for generating derived information that may be included in the flowchart shown in FIG. 13;

FIG. 21 is a representation of a block of code for generating derived information that may be included in the flowchart shown in FIG. 13;

FIG. 22 is a flowchart depicting blocks of code for generating derived information that may be included in the flowchart shown in FIG. 13;

FIG. 23 is a flowchart depicting blocks of code for generating derived information that may be included in the flowchart shown in FIG. 13;

FIG. 24 is a representation of a block of code for generating derived information that may be included in the flowchart shown in FIG. 13;

FIG. 25 is a representation of an exemplary route specific derived information record used by the server in the system shown in FIG. 1;

FIG. 26 is a representation of an exemplary derived route information record used by the server in the system shown in FIG. 1;

FIG. 27A is a partial screen shot depicting part of an exemplary display of original transport information caused by the server to be displayed by the system shown in FIG. 1;

FIG. 27B is a partial screen shot depicting part of the exemplary display shown in FIG. 27A;

FIG. 28 is a representation of an exemplary amended transport route record used by the server in the system shown in FIG. 1;

FIG. 29 is a representation of an exemplary amended transport route record used by the server in the system shown in FIG. 1;

FIG. 30A is a partial screen shot depicting part of an exemplary display of original transport information caused by the server to be displayed by the system shown in FIG. 1;

FIG. 30B is a partial screen shot depicting part of the exemplary display shown in FIG. 30A;

FIG. 31A is a partial screen shot depicting part of an exemplary display of original transport information caused by the server to be displayed by the system shown in FIG. 1;

FIG. 31B is a partial screen shot depicting part of the exemplary display shown in FIG. 31A;

FIG. 32 is a representation caused by the server to be displayed using the system shown in FIG. 1, comparing original derived information, current derived information, and saved derived information;

FIG. 33 is a representation caused by the server to be displayed using the system shown in FIG. 1, comparing original derived information, current derived information, and saved derived information; and

FIG. 34 is a flowchart depicting blocks of code for reverting to saved information that may be included in the flowchart shown in FIG. 13.

### DETAILED DESCRIPTION

### System Overview

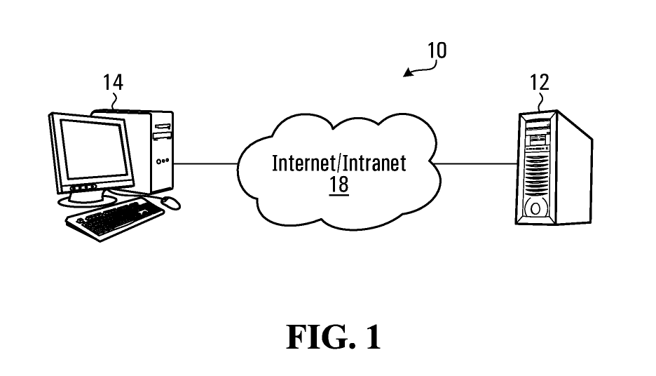

Referring to FIG. 1, a system for facilitating planning of transport routes is shown generally at 10. The system 10 includes a server 12 and a client computer 14. The client computer 14 communicates with the server 12 through a network 18, such as the internet or an intranet, for example.

In the embodiment shown in FIG. 1 and described below, the server 12 and the client computer 14 are separate and communicate over the network 18 to facilitate planning of transport routes. This may allow an owner or licensee of codes stored on the server 12 to, through the control and operation of the server 12, have greater control over and access to the codes than if the codes were stored on the client computer 14. In another embodiment, a single computer, such as the client computer 14, may be configured to perform any or all of the functions described herein as performed by the client computer 14 and/or the server 12. Such an embodiment may allow a user to be able to facilitate planning of transport routes without a network connection, for example.

Referring to the embodiment shown in FIG. 1, a user using the client computer 14 may wish to plan routes for deploying one or more load carriers to deliver or transport at least one load from a load source or warehouse to and/or from at least one location. In various embodiments, the loads to be transported may be any type of load such as people or cargo, for example. The load carriers may be any carrier for carrying the loads, such as a truck, plane, train, car, and/or any suitable vehicle. In one embodiment the load source may be a warehouse, but in other embodiments, the load source may be another source, such as an airport, a train station, or a bus stop, for example. The at least one location to which the loads are to be transported may be any location able to receive the loads, such as, a warehouse, a retail store, an airport, a train station, or a bus stop, for example. In one embodiment, for example, the user may wish to plan and optimize routes for delivering groceries from one or more warehouses to one or more store locations using various carriers of different types and capacities. In some embodiments, the user may also want to use portions of the routes to pick up store orders from vendors or to pick up salvage (e.g., pallets or packaging) from stores.

The user may use the client computer 14 to access the server 12 to plan the routes, such as, through a web browser program on the client computer 14. In one embodiment, the user may, via the client computer 14, cause the server 12 to import or receive load information from the client computer representing the loads to be transported, load source information representing an expected availability or service level associated with the load source, and carrier capacity information representing capacities of the load carriers.

The server 12 may use the load source information and carrier capacity information to generate adjusted carrier capacity information for use in planning routes. In various embodiments, the adjusted carrier capacity information may represent carrier capacities that are greater than carrier capacities represented by the carrier capacity information and so, even when load sources are unable to provide all of any planned load, the portion of the load that they can provide may better fill the capacity of the carrier.

The server 12 may then, based on the adjusted carrier capacity information and the load information, cause transport information to be generated representing a set of transport routes or trips which may be used for transporting the loads from the load source to the locations. The server 12 may send the transport information to the client computer 14 for display to the user. In various embodiments, by using the adjusted carrier capacity information to plan the routes, the load carriers may be more efficiently utilized since they may be filled to capacity even when the load source does not provide them with a full load.

The server 12 may derive information from the transport information and cause the client computer 14 to display both the derived information and the transport information. The derived information may for example, represent various statistics and/or costs related to the planned routes. In various embodiments, the derived information may represent miles driven for the proposed routes and/or costs incurred for driving the routes, for example. The server 12 may allow the user to use the client computer 14 to make changes to the transport information to refine the proposed routes. The server 12 may then derive information from the changed transport information and cause the client computer 14 to display both the changed transport information and a comparison of the information derived from the changed transport information and the information derived from the transport information. The comparison may show, for example, how any or all of the statistics and/or costs have changed as a result of changes to the transport information. Thus, in some embodiments, the user may be able to review the comparison to quickly and easily determine whether the changes made to the transport information were desirable.

### Processor Circuit—Server

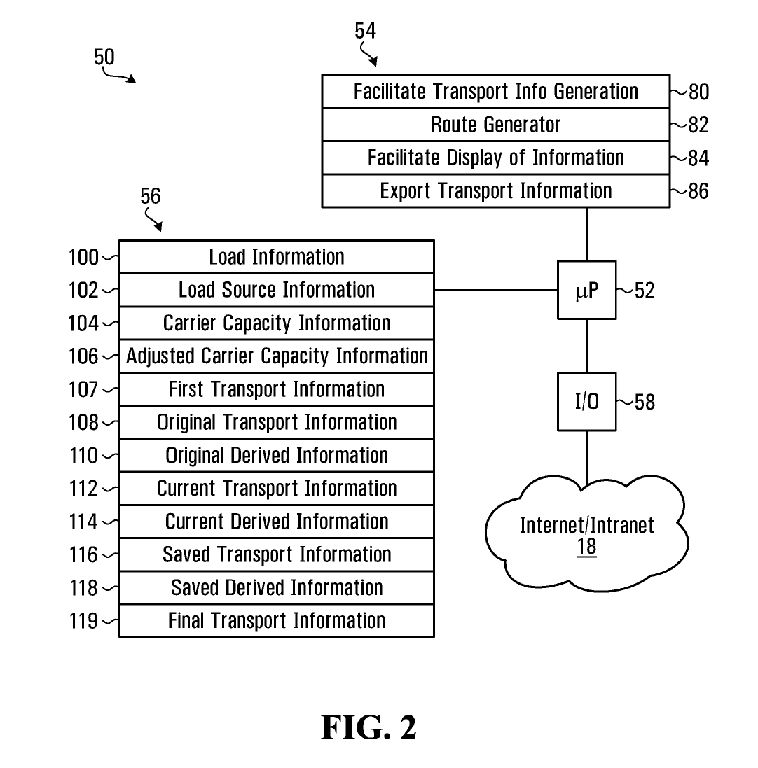

Referring to FIG. 2, a schematic view of a processor circuit for implementing the server 12 in accordance with one embodiment, is shown generally at 50. The processor circuit 50 includes a server processor 52, a program memory 54, a variable memory 56, and an input/output (I/O) interface 58, all of which are in communication with the processor. The I/O interface 58 may include a network interface having a network interface card with an input/output for connecting to the network 18, and through which communications may be conducted with computers connected to the network 18, such as the client computer 14.

In the embodiment shown in FIG. 2, the program memory 54 and the variable memory 56 are included as part of the processor circuit 50. In various other embodiments, the program memory 54, the variable memory 56, or both may be separate from the processor circuit 50 and may be in communication with the server processor 52, through the network 18 connected to the I/O interface 58, for example.

In various embodiments, program codes for directing the server processor 52 to carry out various functions are stored in the program memory 54, which may be implemented as any form of computer-readable memory or storage medium, such as a read only memory (ROM), random access memory (RAM), a hard disk drive (HDD), a network drive, flash memory, and/or a combination thereof.

The program memory 54 includes a block of codes 80 for directing the server processor 52 to facilitate transport information generation for route planning, a block of codes 82 for directing the server processor 52 to effect route generator functions, a block of codes 84 for directing the server processor 52 to facilitate display of information to a user for use in planning transport routes functions, and a block of codes 86 for directing the server processor 52 to facilitate export transport information functions.

The variable memory 56 includes a plurality of storage locations including location 100 for storing load information, location 102 for storing load source information, location 104 for storing carrier capacity information, location 106 for storing adjusted carrier capacity information, location 107 for storing first transport information, location 108 for storing original transport information, location 110 for storing original derived information, location 112 for storing current transport information, location 114 for storing current derived information, location 116 for storing saved transport information, location 118 for storing saved derived information, and location 119 for storing final transport information. In various embodiments, the plurality of storage locations may be stored in a database, such as a relational database, in the variable memory 56. In various embodiments described herein, information stored in the variable memory 56 is stated to be included in various records and/or fields in locations of the variable memory 56. However, it will be appreciated that such information may be stored in any of a plurality of data storage structures including a relational database, for example. In various embodiments, the information may be stored in any format, such as, in additional or alternative tables, records, and/or fields in the variable memory 56.

The variable memory 56 may be implemented as any form of writable computer-readable memory or storage medium, such as any RAM, a hard drive, a network drive, flash memory, and/or any combination thereof.

### Processor Circuit—Client Computer

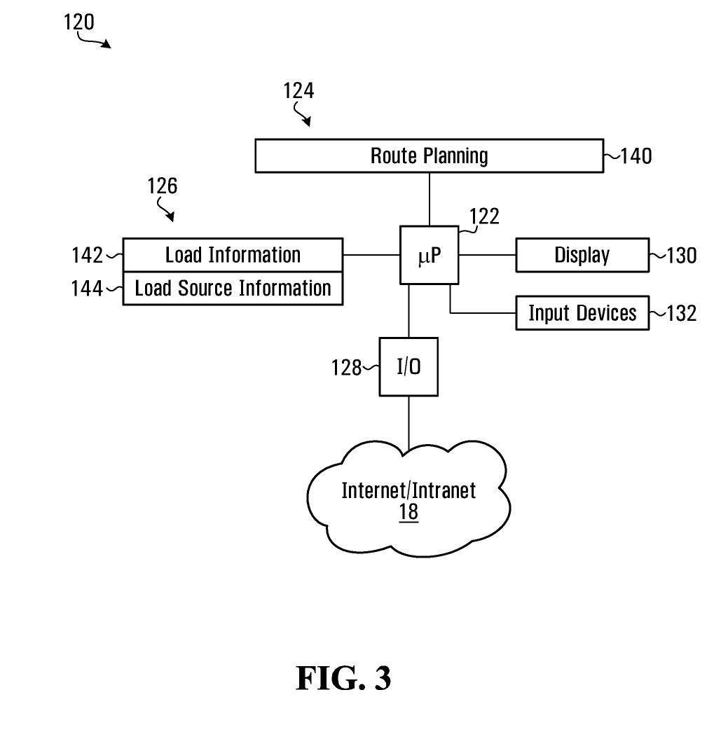

Referring to FIG. 3, a schematic view of a processor circuit for implementing the client computer 14 in accordance with one embodiment, is shown generally at 120. The processor circuit 120 includes a processor 122, a program memory 124, a variable memory 126, a display 130, an input/output (I/O) interface 128, and user input devices 132 all of which are in communication with the processor. The I/O interface 128 may act as a network interface and may include a network interface card having an input/output for connecting to the network 18, through which communications may be conducted with the server 12, for example. The user input devices 132 may include a pointing device such as a cursor or mouse and/or a text input device such as a keyboard.

In various embodiments, the variable memory 126 and the program memory 124 may be implemented generally similar to the way they are implemented in the server processor circuit 50 as discussed above. The program memory 124 includes a block of codes 140 for directing the client processor 122 to effect route planning functions. The variable memory 126 includes a plurality of storage locations including location 142 for storing load information and location 144 for storing load source information.

### Load Information

In one embodiment, a user may wish to plan routes for delivering groceries acting as at least one load from a warehouse, which acts as a load source, to various grocery store locations using a plurality of trucks. Before planning the routes, the user may cause load information to be stored in location 142 of the variable memory 126, the load information representing groceries to be delivered to the store locations. In one embodiment, codes included in the block of codes 140 may direct the client processor 122 to facilitate user entry of the load information via the user input devices 132, for example. In another embodiment, codes included in the block of codes 140 may direct the client processor 122 to facilitate importing the load information to be stored in location 142 by receiving order information from one or more computers associated with the store locations via the network 18, for example.

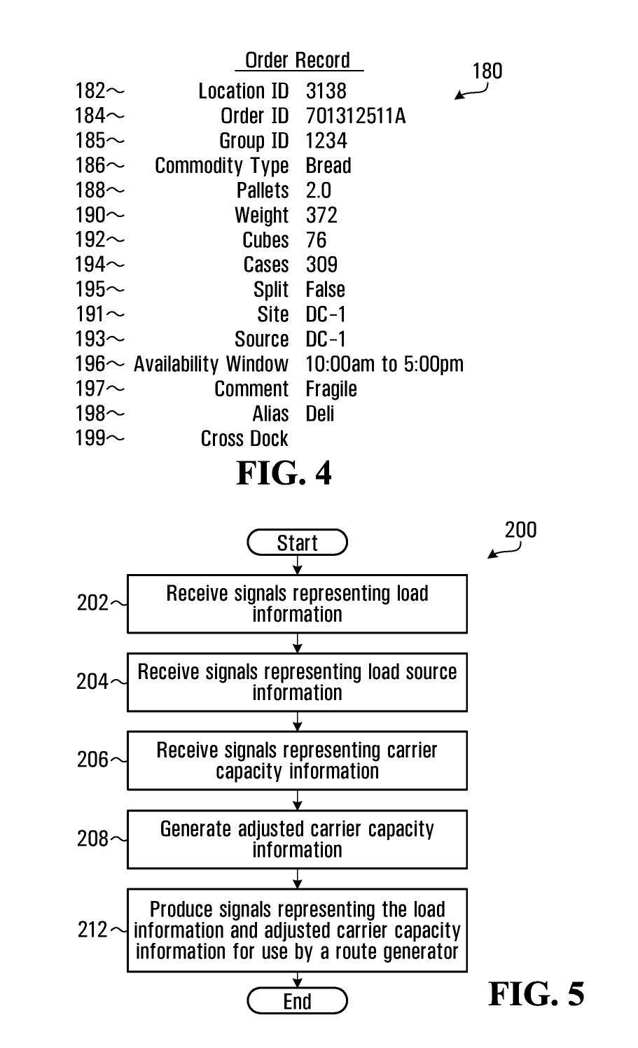

The load information stored in location 142 may include one or more order records representing orders or loads associated with the store locations. A representation of an exemplary order record, in accordance with one embodiment, that may be included in the load information stored in location 142 is shown at 180 in FIG. 4.

The order record 180 includes a location identifier field 182 for storing an identifier that may be used to identify a location, and an order identifier field 184 for storing an identifier or order code assigned to the order record. The order record 180 also includes a group identifier field 185 for storing a group identifier that may be common to a plurality of order records. Order records having the same group identifier may represent orders that are to be transported together by one carrier, for example.

The order record 180 also includes a commodity type field 186 for storing a commodity type indicating the type of commodity associated with the order record. For example, the commodity type field 186 may be chosen from a group of commodity types which may include, for example, bread, meat, egg, and/or produce. In various embodiments, the commodity types may be classified according to a property associated with the commodity type (e.g., frozen, dry or perishable). In various embodiments, the properties associated with the commodity types may be associated with transport temperature requirements, for example.

The order record 180 also includes quantity fields for storing quantities that represent a quantitative characteristic associated with the order. The order record 180 includes a pallet quantity field 188 for storing a number of pallets (which are containers used in goods transport) needed to carry the order, a weight field 190 for storing a weight in pounds of the order, a cube quantity field 192 for storing a number of cubes that the order will occupy in the carrier (in various embodiments, a cube may be defined as a cubic foot), and a case quantity field 194 for storing a number of cases (which are containers used in goods transport to bundle commodities into manageable quantities/sizes and which may vary in size based on commodity weight and fragility) required to carry the order.

The order record 180 also includes a split indicator field 195 for storing a split indicator, such as a boolean value, for indicating whether the order record 180 represents an order that has been split from other orders that it was previously grouped with, for example, to allow a route generator to plan routes wherein the orders can be transported by more than one carrier.

In various embodiments, an order record may also or alternatively include a site field 191 for storing an identifier identifying a distribution centre associated with a client or customer associated with the order, a source field 193 for storing an identifier identifying a source location from which the order is to be transported, an availability window 196 for storing a time when the order can be delivered, a comment field 197 for storing any specific comments associated with the order, an alias field 198 for storing an alternate billing location associated with the order, and/or a cross dock location field 199 for storing a location identifier identifying a cross dock location to be used in delivering the order. In the embodiment shown in FIG. 4, the cross dock location field 199 is not set, but in other embodiments the cross dock location field 199 may store a location identifier such as DC-2, for example.

In the embodiment shown in FIG. 4, the order record 180 is an order for Bread to be delivered to a grocery store identified by the location identifier 3138. The location identifier field 182 is set to 3138, the order identifier field 184 is set to 701312511A, the group identifier field 185 is set to 1234, and the commodity type field 186 is set to “Bread”. The pallet quantity field 188, weight field 190, cube quantity field 192, and case quantity field 194 are set to 2.0, 372, 76, and 309 respectively. The split indicator field 195 is set to False, indicating that the order record 180 represents an order that is not a split order.

In one embodiment, when the user wishes to initiate route planning, the user may use the user input devices 132 to cause the client processor 122 to execute code included in the block of codes 140 for directing the client processor 122 to effect route planning functions. The block of codes 140 directs the client processor 122 to establish a connection with the server 12 by sending an initialization signal through the I/O interface 128 over the network 18 and through the I/O interface 58 to the server 12. In one embodiment, for example, the block of codes 140 may be included in web browser codes on the client computer 14 and block of codes 140 may facilitate logging into the server 12 by the user via a web browser.

When the user is logged into the server 12, the block of codes 140 may direct the client processor 122 to retrieve the load information stored in location 142 of the variable memory 126 and send signals representing the load information through the I/O interface 128 over the network 18 and through the I/O interface 58 of the server 12 to the server processor 52.

### Facilitating Transport Information Generation for Route Planning

Referring to FIG. 5, a flowchart of blocks of code for directing the server processor 52 (shown in FIG. 2) of the server 12 to facilitate transport information generation for route planning is shown generally at 200. The flowchart 200 may be encoded in the block of codes 80 for directing the server processor 52 (shown in FIG. 2) to facilitate transport information generation functions.

The flowchart 200 begins with block 202 which directs the server processor 52 to receive signals representing load information representing at least one load to be transported from a load source to at least one location. As described above, in one embodiment, the client computer 14 sends signals representing the load information stored in location 142 to the server 12. In such an embodiment, block 202 may direct the server processor 52 to receive signals representing the load information from the client computer 14 via the I/O interface 58. Block 202 may then direct the server processor 52 to store the load information in location 100 of the variable memory 56.

In another embodiment, the load information may already be stored in location 100 of the variable memory 56 and signals representing the load information may be considered to be received by the server processor 52 when the load information is retrieved from location 100 in the variable memory 56.

Block 204 then directs the server processor 52 to receive signals representing load source information representing at least one expected availability of the at least one load represented by the load information at the load source. In various embodiments, the load source information may include first and second load source information representing first and second availabilities respectively of the at least one load at the load source. For example, in one embodiment, the first and second availabilities represent an expected availability by weight and an expected availability by volume. In various embodiments, other availabilities may be represented by the load information.

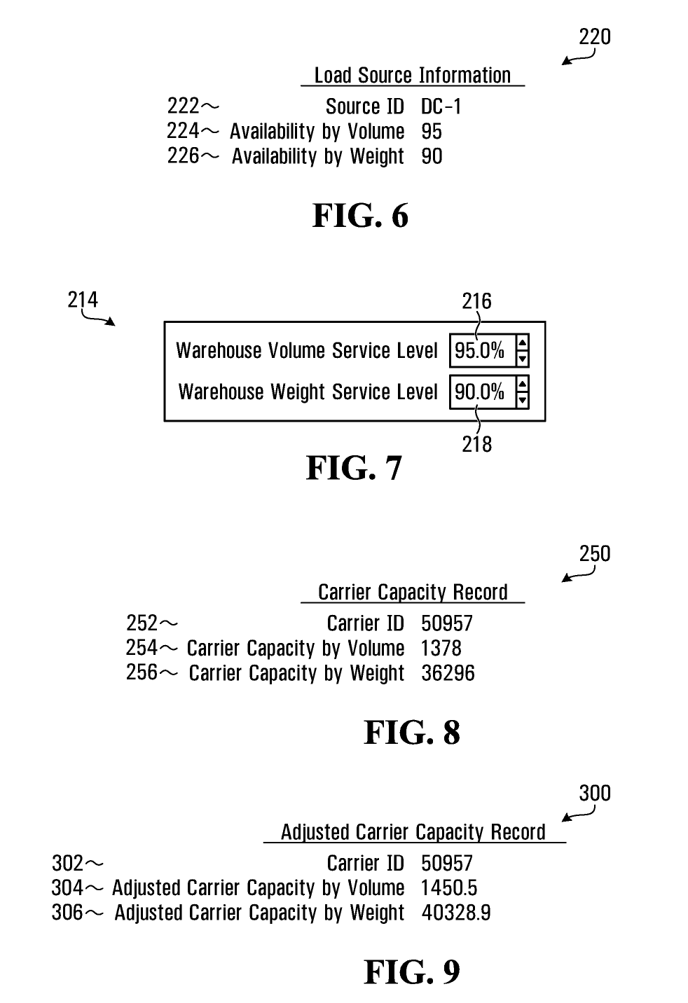

In various embodiments, the signals representing the load source information may be received by the server 12 from the client computer 14. An exemplary representation of load source information that may be stored in location 144 of the variable memory 126 of the client computer 14 and sent to the server 12 is shown at 220 in FIG. 6.

The load source information 220 includes a location identifier field 222 for storing a location identifier identifying a location associated with the load source information, which in the embodiment shown is set to “DC-1” and identifies a grocery warehouse.

The load source information 220 also includes an availability by volume field 224 for storing a percentage representing an availability by volume expected at location identified by the location identifier field 222 and an availability by weight field 226 for storing a percentage representing an availability by weight expected at the location identified by the location identifier field 222. The percentages may represent a proportion of the at least one load expected to be available from the load source. In one embodiment, the availability by volume field 224 and availability by weight field 226 are initialized to each store an initial default value of 100%, but the value may be changed to between 5% and 100%, for example, by a user using the client computer 14. In some embodiments, the expected availability fields may be expected to be set between 95% and 100%.

In one embodiment, block 204 of FIG. 5 directs the server processor 52 to send signals to the client computer 14 for causing block 140 of FIG. 3 to direct the client computer 14 to display a user interface on at least a portion of the display 130, as shown at 214 in FIG. 7. Referring to FIGS. 3 and 7, for example, the user interface 214 may be displayed within a web browser window. The user interface 214 includes a user modifiable representation 216 of the availability by volume field 224 and a user modifiable representation 218 of the availability by weight field 226. The user may interact with the user interface 214 using the user input devices 132 to change one or both of the representations 216 and 218 and thus change the fields 224 and 226 in the load source information stored at location 144 of the variable memory 126.

In one embodiment, the user may be aware, based on past experience, that a warehouse has historically been under stocked on groceries by 5% by volume and therefore the user expects that, for any load that the user wishes to pick up at the warehouse, only 95% by volume of the load will be available for pick up. Accordingly the user may interact with the user interface 214 for example, by using the user input devices 132, to cause the representation 216 to show a value of 95%. Block 140 then directs the client processor 122 to cause the availability by volume field 224 stored in the load source information at location 144 to be set to 95%. The user may also be aware, based on past experience, that the warehouse has historically been under stocked on groceries by 10% by weight and therefore the user expects that, for any load that the user wishes to pick up at the warehouse, only 90% by weight of the load will be available for pick up. Accordingly the user may cause the representation 218 to show a value of 90% for example, by using the user input devices 132. Block 140 then directs the client processor 122 to cause the availability by weight field 226 to be set to 90%.

Once the user is happy with the representations 216 and 218, the user may select a submit icon (not shown) and block 140 directs the client processor 122 to send signals representing the load source information stored in location 144 to the server 12. In embodiments where the load source information was modified by the user using the user input devices 132, the signals representing the load source information act as user input signals, since they represent user input received from the user.

Load sources, due to the type of load that they provide, for example, often have varying differences between their availability by volume and availability by weight. Accordingly, in various embodiments, including separate availability by volume and availability by weight fields 224 and 226 may facilitate better prediction of load availability at a given load source than if only an availability by volume or availability by weight were provided.

Referring back to FIG. 5, in one embodiment block 204 directs the server processor 52 to, in response to receiving the signals from the client computer 14 representing the load source information, store the load source information in location 102 of the variable memory 56 shown in FIG. 2.

In other embodiments, the load source information may already be stored in location 102 and the signals representing the load source information may be considered received when they are retrieved by the server processor 52 from location 102 in the variable memory 56.

Block 206 of FIG. 5 then directs the server processor 52 to receive signals representing carrier capacity information representing respective capacities of one or more load carriers to be used in transporting the at least one load from the load source to the at least one location. In various embodiments, the carrier capacity information may include first and second carrier capacity information representing first and second capacities respectively of the carriers. For example, in one embodiment, the first and second carrier capacities represent a capacity by weight and capacity by volume. In various embodiments, other capacities may be represented by the carrier capacity information.

In one embodiment block 206 directs the server processor 52 to, in response to receiving the signals representing the carrier capacity information, store the carrier capacity information in location 104 of the variable memory 56 shown in FIG. 2.

In one embodiment, the one or more load carriers include a plurality of trucks that are available to transport the loads represented by the load source information from a warehouse to various store locations and the carrier capacity information includes one or more carrier capacity records, each associated with one of the plurality of trucks. An exemplary carrier capacity record associated with a first truck of the plurality of trucks is shown at 250 in FIG. 8.

The carrier capacity record 250 includes a carrier identifier field 252 for storing an identifier value that may be used to identify each carrier, a carrier capacity by volume field 254 for storing a maximum volume capacity in cubes that the carrier can transport, and a carrier capacity by weight field 256 for storing a maximum weight capacity in pounds that the carrier can transport. In the embodiment shown, the carrier identifier field 252 is set to 50957, which identifies the first truck, the carrier capacity by volume field 254 is set to 1,378, and the carrier capacity by weight field 256 is set to 36,296.

In one embodiment, the signals representing the carrier capacity information may be received via the I/O interface 58 from a computer such as the client computer 14 shown in FIG. 3. For example, the carrier capacity information may have been input in the client computer 14 by the user using the input devices 132, and block 140 of FIG. 3 may direct the client computer 14 to send the carrier capacity information to the server 12. In another embodiment, the carrier capacity information may already be stored in location 104 of the variable memory 56 and the signals representing the carrier capacity information may be considered to be received by the server processor 52 when the carrier capacity information is retrieved from location 104 of the variable memory 56.

Referring back to FIG. 5, block 208 directs the server processor 52 to generate adjusted carrier capacity information based on the carrier capacity information and the load source information stored in locations 104 and 102 in the variable memory 56 and to store the adjusted carrier capacity information in location 106 of the variable memory 56 shown in FIG. 3.

In various embodiments, the adjusted carrier capacity information may include first and second adjusted carrier capacity information representing first and second adjusted capacities respectively of the carriers. For example, in one embodiment, the first and second adjusted carrier capacities represent an adjusted capacity by weight and an adjusted capacity by volume. In various embodiments, other adjusted capacities may be represented by the adjusted carrier capacity information.

In various embodiments, the adjusted carrier capacity information includes respective adjusted carrier capacity records associated with each of the carrier capacity records included in the carrier capacity information stored in location 104 of the variable memory 56 shown in FIG. 2. An exemplary adjusted carrier capacity record is shown at 300 in FIG. 9. The adjusted carrier capacity record 300 has a similar format to the carrier capacity record 250 shown in FIG. 8 and includes a carrier identifier field 302, an adjusted carrier capacity by volume field 304 and an adjusted carrier capacity by weight field 306. The adjusted carrier capacity record 300 shown in FIG. 9 is associated with and corresponds to the carrier capacity record 250 shown in FIG. 8 because the carrier identifier field 302 is set to the same value as the carrier identifier field 252.

Referring to FIG. 5, block 208 directs the server processor 52 to set the adjusted carrier capacity by volume field 304 shown in FIG. 9 to a value equal to the carrier capacity by volume 254 of the corresponding carrier capacity record 250 shown in FIG. 8 (set to 1,378 cubes in the embodiment shown) multiplied by a volume adjustment factor that is inversely proportional to the value stored in the availability by volume field 224 shown in FIG. 6 (set to 95 in the embodiment shown) included in the load source information stored in location 102 of the variable memory 56 shown in FIG. 2.

In one embodiment, the volume adjustment factor is set to 100 divided by the value of the availability by volume field 224. In such an embodiment block 208 may, for example, direct the server processor 52 to set the adjusted carrier capacity by volume field 224 to 1,378*100/95=1450.5 cubes such that the adjusted carrier capacity record 300 represents an adjusted carrier capacity by volume of 1450.5 cubes.

Referring to FIG. 9, for generating the adjusted carrier capacity record 300, block 208 of FIG. 5 directs the server processor 52 to set the adjusted carrier capacity by weight field 306 to the value of the carrier capacity by weight field 256 shown in FIG. 8 (i.e. 36,296 lbs) multiplied by a weight adjustment factor that is inversely proportional to the value of the availability by weight field 226 shown in FIG. 6 (i.e., 90).

In one embodiment, the weight adjustment factor is set to 100 divided by the value of the availability by weight field 226 and so the adjusted carrier capacity by weight field 306 is set to equal to 36,296*100/90=40328.9 lbs. In such an embodiment, the adjusted carrier capacity record 300 shown in FIG. 9 represents an adjusted carrier capacity by weight of 40328.9 lbs.

The process described above for the adjusted carrier capacity record 300 may be repeated for each adjusted carrier capacity record included in the adjusted carrier capacity information. Thus, block 208 of FIG. 5 directs the server processor 52 to cause the adjusted carrier capacity information stored in location 106 of the variable memory 56 shown in FIG. 2 to represent adjusted carrier capacities by volume that are proportionately greater than the carrier capacities by volume represented by the carrier capacity information stored in location 104 of the variable memory 56 by the volume adjustment factor. Block 208 also directs the server processor 52 to cause the adjusted carrier capacity information stored in location 106 to represent adjusted carrier capacities by weight that are proportionately greater than the carrier capacities by weight represented by the carrier capacity information stored in location 104 of the variable memory 56 by the weight adjustment factor.

In the embodiment shown, the weight and volume adjustment factors are chosen so that, if routes and loads are planned for the trucks using the adjusted capacities and a warehouse has available the expected percentages of the planned loads, the available loads will fill the non-adjusted capacity of the trucks. Of course, in some embodiments, there may be a risk that the warehouse will have more than the expected availability for the loads and in such cases, there will be overage, as the trucks will not be able to carry the entire available load. However, generally, by using adjusted carrier capacities to plan the routes instead of the original carrier capacities, efficiency over time of the routes may be increased.

Referring to FIG. 5, block 212 directs the server processor 52 of FIG. 2 to produce signals representing the load information and carrier information including the adjusted carrier capacity information for use by a route generator in generating transport information. In one embodiment, block 212 directs the server processor 52 to produce signals representing the load information and the carrier information including the adjusted carrier capacity information by directing the server processor to retrieve the load information and the adjusted carrier capacity information from locations 100 and 106 respectively of the variable memory 56.

In one embodiment, the server 12 acts as a route generator by executing route generator codes encoded in the block 82 of the program memory 54 for directing the server processor 52 to effect route generator functions. In other embodiments, the route generator may be included in a computer or processor circuit that is separate from the processor circuit 50 and in communication with the server processor 52 through the I/O interface 58, for example. In such embodiments, block 212 may direct the server processor 52 to send to the route generator via the I/O interface 58, signals representing the load information and the carrier information including the adjusted carrier capacity information.

In an embodiment where the server 12 acts as the route generator, the route generator codes encoded in the block 82 may direct the server processor 52 to generate transport information including a set of proposed transport route records, wherein each proposed transport route record represents a proposed transport route to be used for transporting at least one load from a load source to at least one location using one or more load carriers. The route generator may generate the transport information such that each of the orders represented by the load information is planned to be delivered to their associated location, by at least one of the carriers. Block 82 may direct the server processor 52 to store the generated transport information in location 107 as first transport information.

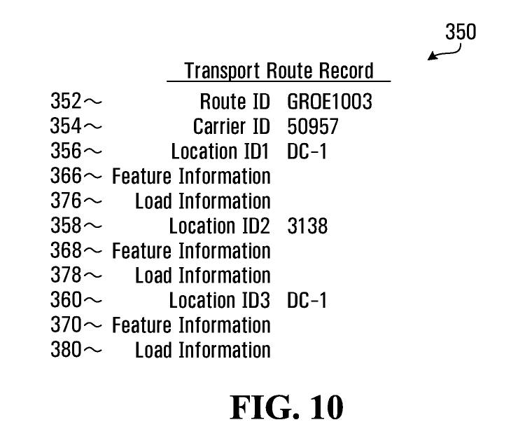

An exemplary transport route record that may be included in the transport information is shown at 350 in FIG. 10. The transport route record 350 includes a route identifier field 352 for storing an identifier for identifying each route, and a carrier identifier field 354 for storing a carrier identifier identifying a carrier for the route. The transport route record 350 also includes a set of location identifier fields 356, 358, and 360 for storing location identifiers identifying stops along the route and representing the route. The location identifiers stored in the location identifier fields 356, 358, and 360 may act as an ordered set, with location identifiers stored in the location identifier fields 356 and 358 acting as consecutive location identifiers and location identifiers stored in the location identifier fields 358 and 360 also acting as consecutive location identifiers.

In the embodiment shown, the location identifiers stored in the location identifier fields 356, 358, and 360 are set to DC-1, 3138, and DC-1 respectively. Thus, the set of the location identifiers stored in the location identifier fields 356, 358 and 360 included in the transport route record represent a route that travels from the location identified by DC-1 to the location identified by 3138 then back to the location identified by DC-1.

The transport route record 350 also includes feature or location information records 366, 368, and 370 and load information records 376, 378, and 380 associated with each of the location identifier fields 356, 358, and 360 respectively. In various embodiments, feature information records may include location information that is static for any load to be handled at the location and the load information records may include load and travel information that varies according to each load and route. The contents of the feature information records 366, 368, and 370 and the load information records 376, 378, 380 are not shown in FIG. 10, but are discussed in further detail below.

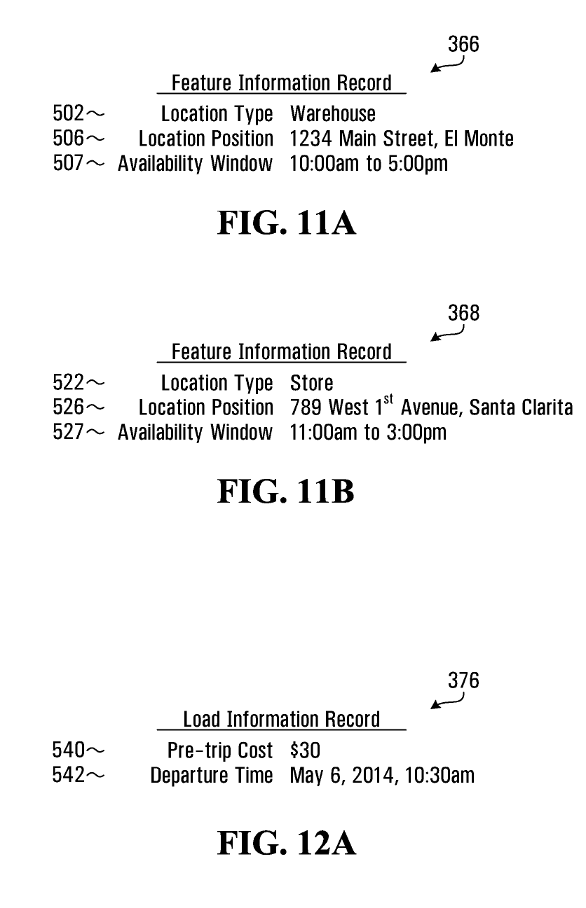

Exemplary representations of the feature information records 366 and 368 associated with the location identifier fields 356 and 358 are shown in FIGS. 11A and 11B. In the embodiments shown, the feature information records 366 and 368 include respective location type fields 502 and 522 for storing a type of location that describes the location identifier they are associated with. Examples of various location types that may populate the location type fields include “Warehouse” or “Distribution Centre”, “Store”, or “Vendor”.

The feature information records 366 and 368 also include location position fields 506 and 526 for storing positions of the respective locations. In various embodiments, the location position field may be populated with a GPS position of the location or an address of the location, for example.

In the embodiment shown, for the feature information record 366, the location type field 502 is set to Warehouse and the location position field 506 is set to an address, i.e., 1234 Main Street, El Monte. For the feature information record 368 shown in FIG. 11B, the location type field 522 is set to Store and the location position field 526 is set to an address, i.e., 789 West 1st Avenue, Santa Clarita.

In the embodiments shown, the feature information records 366 and 368 also include respective availability window fields 507 and 527 for storing a range of availability times representing times when the associated locations are available or open, such as for pick up or for deliveries. In the embodiment shown, the availability window field 507 is set to 10:00 am to 5:00 pm and the availability window field 527 is set to 11:00 am to 3:00 pm.

In various embodiments, the feature information record 370 may be generally similar to the feature information record 366.

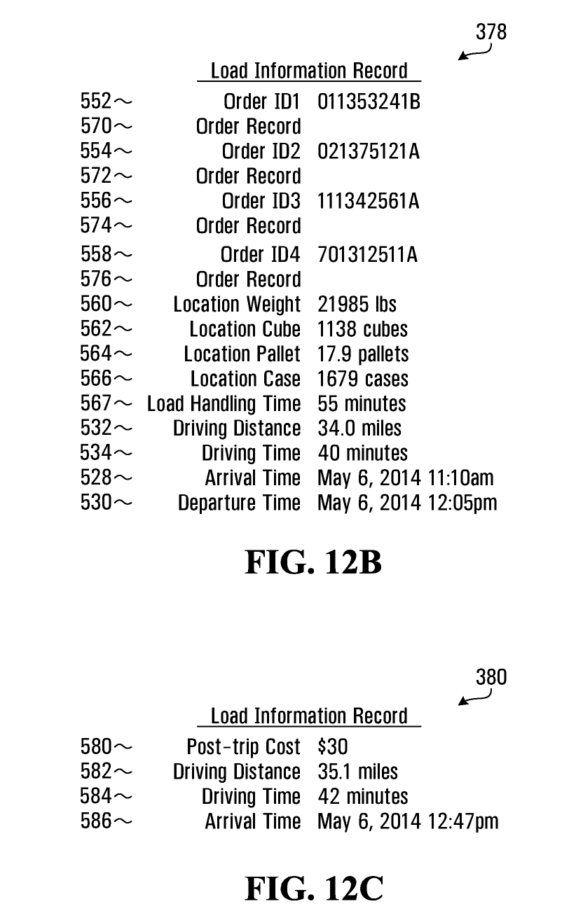

Referring to FIG. 12A, an exemplary representation of the load information record 376 associated with the location identifier 356 in accordance with one embodiment is shown. The load information record 376 includes a pre-trip cost field 540 for storing a cost associated with preparing the carrier identified by the carrier identifier field 354 for a trip. For example, the pre-trip cost field 540 may store a cost for performing an inspection of the carrier. In the embodiment shown, the pre-trip cost field 540 is set to $30. The load information record 376 also includes a departure time field 542 for storing a time that the carrier is planned to depart from the location. In the embodiment shown in FIG. 12A, the departure time field is set to May 6, 2014, 10:30 am.

Referring to FIG. 12B, an exemplary representation of the load information record 378 in accordance with one embodiment is shown. The load information record 378 includes order identifier fields 552, 554, 556, and 558 for storing order identifiers identifying the orders that are to be handled at the location identified by the location identifier 356. In the embodiment shown, the order identifier fields 552, 554, 556, and 558 are set to 011353241B, 021375121A, 111342561A, and 701312511A respectively and identify orders that are to be delivered to the location associated with the location identifier 3138.

In one embodiment, the load information record 378 also includes, for each of the order identifier fields 552, 554, 556, and 558, respective order records 570, 572, 574, and 576 which may include information similar to the information included in the order record 180 discussed above. For example, each of the order records 570, 572, 574, and 576 may include an order identifier field, a location identifier field, a group identifier field, commodity type field, a weight field, a cube quantity field, a pallet quantity field, a case quantity field, and a split indicator field.

In the embodiment shown, the load information record 378 also includes a location weight field 560 for storing a total weight to be transported to the location, a location cube quantity field 562 for storing a total cube quantity to be transported to the location, a location pallet quantity field 564 for storing a total pallet quantity to be transported to the location, and a location case quantity 566 for storing a total case quantity to be transported to the location. In various embodiments the route generator codes may direct the server processor 52 shown in FIG. 2 to calculate the fields 560, 562, 564, and 566 by aggregating or summing respective quantities included in the order records 570, 572, 574, and 576.

The load information record 378 also includes a load handling time field 567 for storing a time representing an amount of time that it is expected for the orders associated with the order identifier fields 552, 554, 556, and 558 to be handled. In various embodiments, the route generator codes encoded in the block 82 may direct the server processor 52 shown in FIG. 2 to calculate and set the value of the load handling time field 567 as a sum of load handling times calculated for each of the orders. The load handling time of a particular order may be calculated based on the commodity type of the order, which may be associated with a particular per pallet load handling time, for example. In various embodiments, the route generator codes encoded in the block 82 may direct the server processor 52 to also include a fixed set-up time in the load handling time.

In the embodiment shown, because the orders are being dropped off, the load handling time field 567 represents an expected unloading time. In other embodiments, a load handling time field may represent an expected loading time or an expected combined loading and unloading time, for example.

The load information record 378 also includes a driving distance field 532 and a driving time field 534 for storing a driving distance and driving time respectively between locations identified by the consecutive location identifiers stored in the location identifier fields 356 and 358. The values stored in the driving distance and time fields 532 and 534 each act as travel branch information and may be derived from the location position fields 506 and 526 associated with the consecutive location identifiers stored in the location identifier fields 356 and 358.

In various embodiments, the route generator codes encoded in the block 82 may direct the server processor 52 shown in FIG. 2 to set the value of the driving distance field 532 of FIG. 12B by using an application, such as PC*Miler™, to determine a driving distance between the location stored in the location position field 506 and the location stored in the location position field 526. In one embodiment, the server processor 52 may be directed to calculate the value of the driving time field 534 by dividing the distance stored in the driving distance field 532 by an average speed to determine a predicted driving time between the location stored in the location position field 506 and the location stored in the location position field 526.

The load information record 378 shown in FIG. 12B also includes an arrival time field 528 storing an expected arrival time at the location and a departure time field 530 storing an expected departure time from the location. In various embodiments, the route generator codes encoded in the block 82 may direct the server processor 52 to set the arrival time field 528 by adding the value stored in the driving time field 534 to the value of the departure time field 542 associated with the preceding location identifier. The route generator codes encoded in the block 82 may direct the server processor 52 to set the departure time field 530 by adding the load handling time stored in the load handling time field 567 to the time stored in the arrival time field 508.

Referring to FIG. 12C, an exemplary representation of the load information record 380 in accordance with one embodiment is shown. The load information record 380 includes a post-trip cost field 580 storing a cost associated with preparing the carrier identified by the carrier identifier field 354 for a next trip. For example, the post-trip cost field 580 may store a cost for performing an inspection of the carrier. The load information record 380 also includes a driving distance field 582, a driving time field 584, and an arrival time field 586.

### Facilitating Display

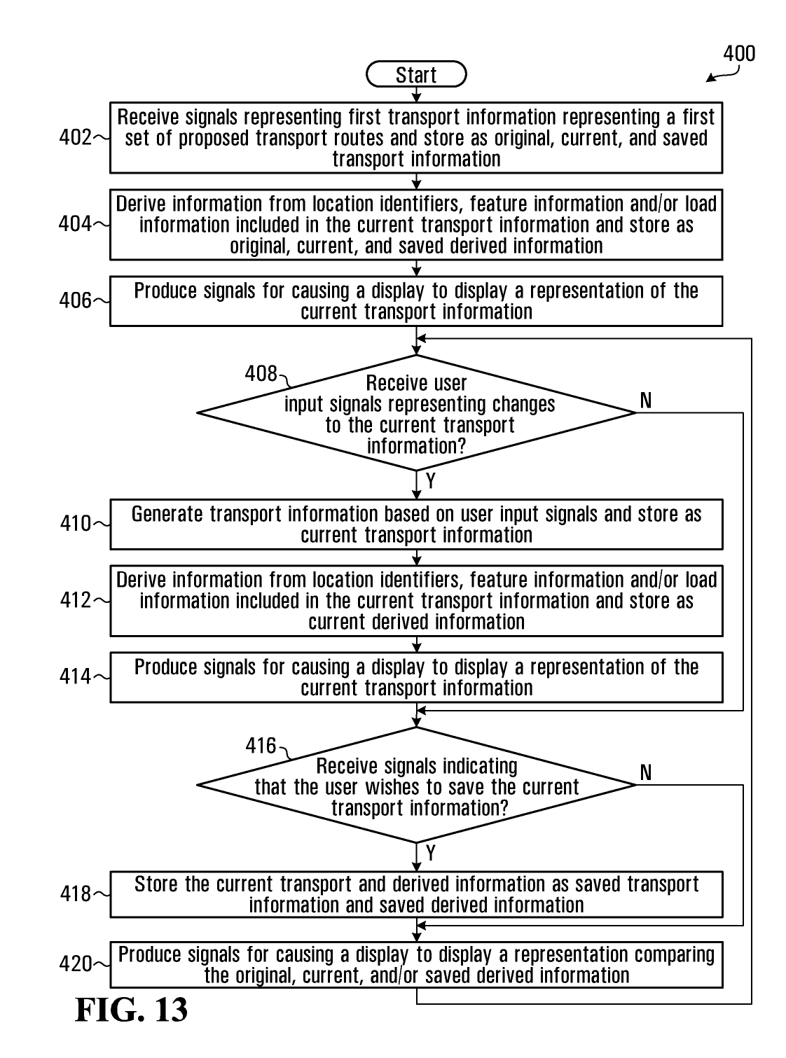

In one embodiment, after the transport information representing the routes has been generated by the route generator, the server 12 may facilitate display of information to a user for use in planning the routes. Referring to FIG. 13, a flowchart of blocks of code for directing the server processor 52 of the server 12 to facilitate display of information to a user for use in planning transport routes is shown generally at 400. In various embodiments, the flowchart 400 may be encoded in the block of codes 84, for example.

The flowchart 400 begins with block 402 which directs the server processor 52 to receive signals representing first transport information representing a first set of proposed transport routes. For example, in one embodiment, block 402 may direct the server processor 52 to retrieve the first transport information from location 107 of the variable memory 56. In another embodiment block 402 may direct the server processor 52 to receive the first transport information via the I/O interface 58 from another computer or processor circuit acting as a route generator, for example.

In various embodiments, the first transport information may include one or more proposed transport route records each having a format generally similar to the transport route record 350 shown in FIG. 10. Thus, the first transport information may include sets of location identifiers that act as first sets of first location identifiers, feature information records that act as first feature information records, load information records that act as first load information records, route identifiers that act as first route identifiers, and carrier identifiers that act as first carrier identifiers.

In various embodiments, block 402 of FIG. 13 directs the server processor 52 to store the received first transport information in location 108 of the variable memory 56 shown in FIG. 2, as original transport information. In some embodiments, block 402 also directs the server processor 52 to initialize locations 112 and 116 of the variable memory 56 by storing the received first transport information in locations 112 and 116 as current transport information and saved transport information respectively.

Block 404 of FIG. 13 then directs the server processor 52 to derive information from at least one of the location identifiers, the feature information, and the load information included in the original transport information stored in location 108 of the variable memory and to store the derived information as original derived information in location 110 of the variable memory 56 shown in FIG. 2. In various embodiments, block 404 also directs the server processor 52 to initialize locations 114 and 118 of the variable memory 56 by storing the derived information in locations 114 and 118 of the variable memory as current derived information and saved derived information respectively.

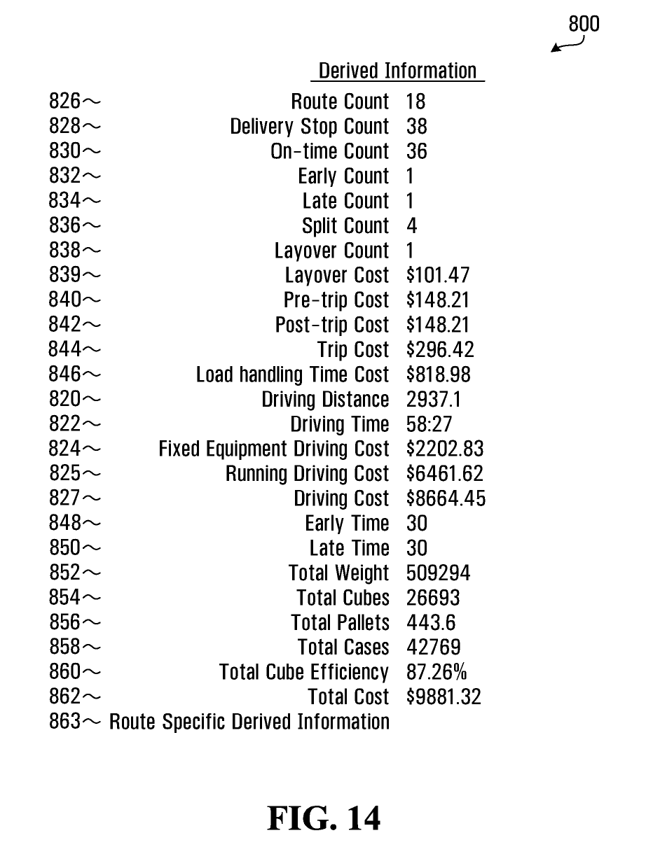

An exemplary representation of derived information that may be derived from the first transport information stored as the original transport information in accordance with one embodiment is shown at 800 in FIG. 14. The derived information 800 includes a route count field 826, a total delivery stop count field 828, a total on time count field 830, a total early count field 832, a total late count field 834, a total split count field 836, a total layover count field 838, a total layover cost field 839, a total pre-trip cost field 840, a total post-trip cost field 842, a total trip cost field 844, a total load handling time cost field 846, a total driving distance field 820, a total driving time field 822, a total fixed equipment driving cost field 824, a total running driving cost field 825, a total driving cost field 827, a total early time field 848, a total late time field 850, a total weight field 852, a total cube quantity field 854, a total pallet quantity field 856, a total case quantity field 858, a total cube efficiency field 860, a total cost field 862, and a route specific derived information record 863. In various embodiments, the derived information 800 may include any or all of the above fields. In various embodiments, when these fields are included in the derived information, they may be populated as described below.

Block 404 of FIG. 13 may include various blocks of code for directing the server processor 52 to derive various information from the original transport information. Some of the blocks of code that may be included in the block 404 in various embodiments of the invention are described below

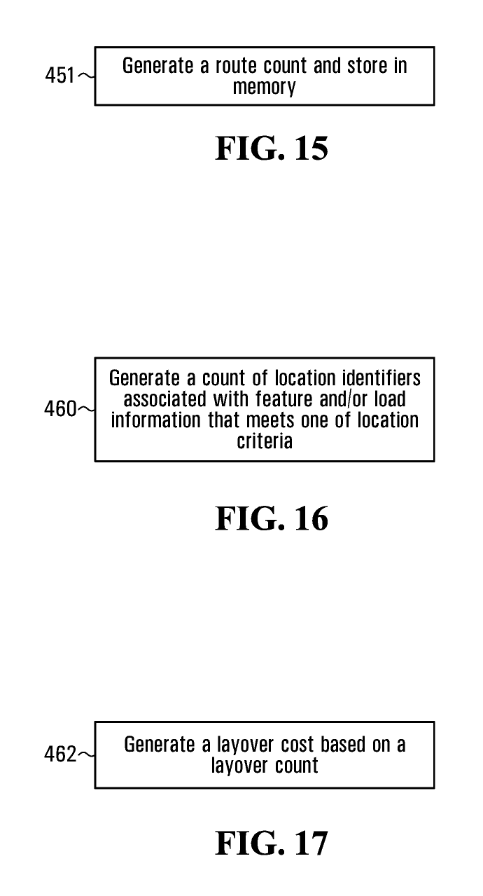

In one embodiment, block 404 includes a block 451 as shown in FIG. 15. Block 451 directs the server processor 52 shown in FIG. 2 to generate a route count representing a total number of routes included in the original transport information. In one embodiment, for example, block 451 may direct the server processor 52 to generate the route count by counting sets of location identifiers, for example, by counting the transport route records included in the original transport information. Block 451 may direct the server processor 52 to store the route count in a total route count field of the derived information.

In one embodiment, where the original transport information includes 18 transport route records, block 451 directs the server processor 52 to generate a route count of 18 and to store the route count in a route count field such as the route count field 826 shown in FIG. 14.

In one embodiment, block 404 of FIG. 13 includes a block 460 as shown in FIG. 16. Block 460 may direct the server processor 52 to generate a count of location identifiers included in the original transport information that are associated with feature information records and/or load information records that meet one of one or more location criteria. In various embodiments, variations of block 460 may be run a plurality of times to generate a plurality of counts, each of the counts representing a count of location identifiers associated with feature information records and/or load information records that meet one of the location criteria. In various embodiments, block 460 may direct the server processor 52 to include the counts in the derived information.

In one embodiment, the location criteria may include a delivery stop criterion. The delivery stop criterion may be met by feature information records that indicate that a location associated with the feature information record is a delivery stop. In one embodiment, block 460 may direct the server processor 52 to determine that a feature information record associated with a location identifier meets the delivery stop criterion when the feature information record includes a location type field storing a value that indicates the location is a delivery stop. For example, block 460 may direct the server processor 52 to determine that the location identifier field 358 of FIG. 10 is associated with a feature information record that meets the delivery stop criterion because a location type of “Store” stored in the location type field 502 indicates that the location is a delivery stop. Block 460 may direct the server processor 52 to determine that the location identifier field 360 is associated with a feature information record that does not meet the delivery stop criterion because the location identifier field 360 is associated with the location type field 522 which is set to Warehouse indicating that the location is a warehouse and therefore not a delivery stop. In various embodiments, a location type of “Vendor” may indicate that the location is a delivery stop.

In one embodiment, for example, the original transport information may include 38 location identifiers that are associated with feature information records that meet the delivery stop criterion. Accordingly, block 460 of FIG. 16 may direct the server processor 52 to generate a total delivery stop count of 38 and to store the total delivery stop count in the total delivery stop count field 828 shown in FIG. 14.

In one embodiment, the location criteria may include an on time criterion and the count may be a total on time count. The on time criterion may be met by a feature information record and a load information record that indicate an on time scheduled stop. In one embodiment, block 460 of FIG. 16 may direct the server processor 52 of FIG. 2 to determine that feature and load information records associated with a location identifier meet the on time criterion when the load information record includes an arrival time and a departure time that are both within an availability window included in the feature information record. For example, block 460 may direct the server processor 52 to determine that the location identifier field 358 of FIG. 10 is associated with feature and load information records that meet the on time criterion because the location identifier field 358 is associated with the arrival time field 528 of FIG. 12B storing May 6, 2014, 11:10 am and the departure time field 530 storing May 6, 2014, 12:05 pm, both of which are within the availability window field 527 storing 11:00 am to 3:00 pm.

In one embodiment, the original transport information may include 36 location identifiers that are associated with feature and load information records that meet the on time criterion. Accordingly, block 460 directs the server processor 52 to generate a total on time count of 36 and to store the total on time count in the total on time count field 830 shown in FIG. 14.

In another embodiment, the location criteria may include an early criterion and the count may be a total early count. The early criterion may be met by feature information records and load information records that indicate that a scheduled stop is before a preferred window of time. In one embodiment, block 460 may direct the server processor 52 to determine that feature and load information records associated with a location identifier meet the early criterion when the load information record includes an arrival time that is outside of and before an availability window included in the feature information record. For example, in an alternative embodiment to the one shown in FIG. 12B, the arrival time field 528 may be set to May 6, 2014, 10:30 am. In such an embodiment, block 460 may direct the server processor 52 to determine that the location identifier field 358 of FIG. 10 is associated with feature and load information that meets the early criterion because the arrival time field 528 of FIG. 12B is set to a time that is outside of and before the window of 11:00 am to 3:00 pm stored in the availability window field 527.

In one embodiment, the original transport information may include 1 location identifier that is associated with feature and load information records that meet the early criterion. Accordingly, block 460 directs the server processor 52 to generate a total early count of 1 and to store the total early count in the total early count field 832 shown in FIG. 14.

In another embodiment, the location criteria may include a late criterion and the count may be a total late count. The late criterion may be met by feature information and load information that indicate a scheduled stop is later than an allowed or preferred window of time. In one embodiment, block 460 of FIG. 16 may direct the server processor 52 to determine that feature and load information records associated with a location identifier meet the late criterion when the load information record includes a departure time that is outside of and after an availability window included in the feature information record. For example, in an alternative embodiment to the one shown in FIG. 12B, the departure time field 530 may be set to May 6, 2014, 3:30 pm. In such an embodiment, block 460 may direct the server processor 52 to determine that the location identifier 358 of FIG. 10 is associated with feature and load information records that meets the late criterion because the departure time field 530 is set to a time that is outside of and after the window of 11:00 am to 3:00 pm stored in the availability window field 527.

In one embodiment, the original transport information may include 1 location identifier that is associated with feature and load information records that meet the late criterion. Accordingly, block 460 of FIG. 16 directs the server processor 52 to generate a total late count of 1 and to store the total late count in the total late count field 834 shown in FIG. 14.

In another embodiment, the location criteria may include a split criterion and the count may be a total split count. The split criterion may be met by a load information record that indicates that an order identifier included in the load information identifies an order that has been split. In one embodiment, block 460 may direct the server processor 52 to determine that a load information record associated with a location identifier meets the split criterion when the load information record includes a split indicator that is set to True. For example, in an alternative embodiment to the one shown in FIG. 12B, a split indicator field included in the order record 576 may be set to True. In such an embodiment, block 460 may direct the server processor 52 to determine that the location identifier 358 of FIG. 10 is associated with load information that meets the split criterion because the load information includes a split indicator set to True.

In one embodiment, the original transport information may include 4 location identifiers that are associated with load information records that meet the split criterion. Accordingly, block 460 directs the server processor 52 to generate a total split count of 4 and to store the total split count in the total split count field 836 shown in FIG. 14.

In another embodiment, the location criteria may include a layover criterion and the count may be a total layover count. The layover criterion may be met by a load information record that indicates that a pilot or driver of a carrier must layover or stay overnight at a location while traveling the route defined by the transport route record. In one embodiment, block 460 of FIG. 16 may direct the server processor 52 shown in FIG. 2 to determine that a load information record associated with a location identifier meets the layover criterion when the load information record includes an arrival time that is on a different day from another arrival time or departure time included in the load information record or another load information record associated included in the transport route record. For example, in an alternative embodiment to the one shown in FIG. 12B, the arrival time field 528 may be set to May 7, 2014, 11:10 am. In such an embodiment, block 460 may direct the server processor 52 to determine that the location identifier field 358 of FIG. 10 is associated with load information that meets the layover criterion because the arrival time field 528 is set to a different day (i.e., May 7) from the departure time field 542 which is set to May 6, 2014, 10:00 am.

In one embodiment, the original transport information may include 1 location identifier that is associated with a load information record that meets the layover criterion. Accordingly, block 460 directs the server processor 52 to generate a total layover count of 1 and to store the total layover count in the total layover count field 838 shown in FIG. 14.

In one embodiment, where block 404 of FIG. 13 includes block 460 and the location criteria includes the layover criterion, block 404 may further include block 462, as shown in FIG. 17, to be executed following block 460. Block 462 may direct the server processor 52 to generate a layover cost based on a layover count of location identifiers that are associated with load information records that meet the layover criterion. In one embodiment, block 462 may direct the server processor 52 to generate the layover cost by multiplying the layover count by a cost per layover, which may be set to $101.47/layover for example. The layover cost may represent an amount to be paid to any carrier pilot or driver to compensate for having to layover during the route. Block 462 may then direct the server processor 52 to include the layover cost in the derived information.

For the embodiment shown in FIG. 14, the total layover count field 838 was set to 1 and so block 462 directs the server processor 52 to set the total layover cost field 839 to be equal to 1×$101.47=$101.47.

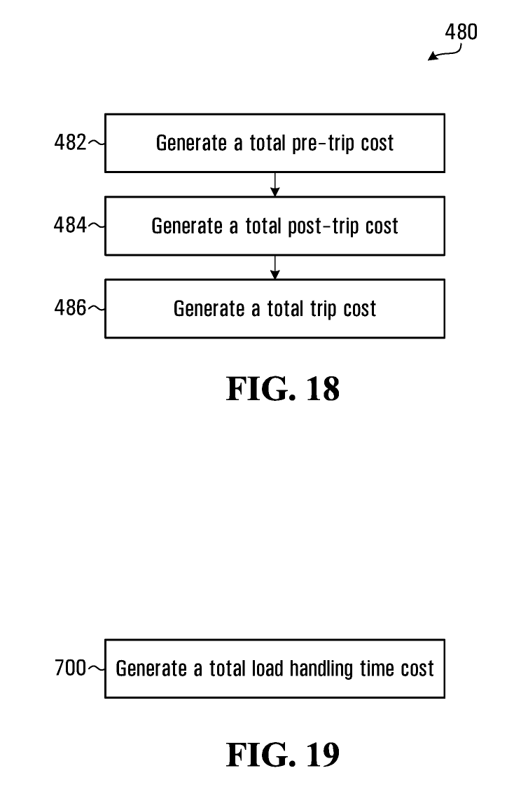

Referring to FIG. 18, a flowchart of blocks of code to be included in the block 404 of FIG. 13, in accordance with one embodiment, is shown generally at 480. The flowchart 480 directs the server processor 52 shown in FIG. 2 to generate trip costs based on at least one of the feature information records and the load information records included in the original transport information.

The flowchart 480 begins with block 482 which directs the server processor 52 to generate a total pre-trip cost by aggregating or summing pre-trip costs (e.g. including the cost stored in the pre-trip cost field 540 shown in FIG. 12A) included in load information records of the original transport information. In various embodiments, block 482 may direct the server processor 52 to include the total pre-trip cost in the derived information stored in location 110 of the variable memory 56, for example.

In one embodiment, a sum of pre-trip costs included in the first load information records of the original transport information may be $148.21 and block 482 directs the server processor 52 to set the total pre-trip cost field 840 to $148.21.

Block 484 of FIG. 18 directs the server processor 52 to generate a total post-trip cost by aggregating or summing post-trip costs (e.g. including the cost stored in the post-trip cost field 580 shown in FIG. 12C) included in load information records of the original transport information. In various embodiments, block 484 may direct the server processor 52 to include the total post-trip cost in the derived information stored in location 110 of the variable memory 56 shown in FIG. 2.

In one embodiment, a sum of post-trip costs included in the load information records of the original transport information may be $148.21 and block 484 directs the server processor 52 to set the total post-trip cost field 842 of FIG. 14 to $148.21.

Block 486 of FIG. 18 directs the server processor 52 to generate a total trip cost. In one embodiment, block 486 directs the server processor 52 to generate the total trip cost by summing or aggregating the total post-trip cost and the total pre-trip cost. In various embodiments, the total trip cost is a function of other costs and so the total trip cost acts as a composite cost. Block 486 directs the server processor 52 to include the total trip cost in the derived information stored in location 110 of the variable memory 56 shown in FIG. 2.

In one embodiment, block 486 directs the server processor 52 to sum the cost stored in the total pre-trip cost field 840 and the cost stored in the total post-trip cost field 842 to generate a total trip cost of $296.42 and block 486 directs the server processor 52 to set the total trip cost field 844 of FIG. 14 to $296.42.

In one embodiment, block 404 of FIG. 13 may include a block 700 as shown in FIG. 19. Block 700 directs the server processor 52 to generate a total load handling time cost based on the load information records included in the original transport information. The total load handling time cost may, for example, represent a total cost associated with loading and/or unloading loads at locations identified by the location identifiers included in the load information stored in location 108 of the variable memory. In one embodiment, block 700 may direct the server processor 52 to generate a total load handling time by aggregating or summing load handling times (e.g. including time stored in the load handling time field 567 shown in FIG. 12B) included in load information records of the transport information stored in location 108 of the variable memory 56 shown in FIG. 2 and multiplying the total load handling time by a load handling cost rate.

In another embodiment, block 700 of FIG. 19 may direct the server processor 52 to generate the total load handling time cost by generating a load handling time cost associated with each load information record and summing these costs. Block 700 may direct the server processor 52 to generate the load handling time cost associated with a load information record by summing a fixed cost (e.g. $3.50) with an order cost for unloading the orders. The order cost for each order may be calculated by multiplying a quantity associated with the order with a unit unloading cost that is specific to each commodity type For example, in one embodiment, an order may include 10 pallets of bread and bread may be associated with a user defined unit unloading cost of $0.85/pallet. In such an embodiment, block 700 may direct the server processor 52 to generate the load handling time cost associated with the order as $3.50+10 pallets×$0.85/pallet=$12.00.

In various embodiments, block 700 may direct the server processor 52 to include the total load handling cost in the derived information stored in location 110 of the variable memory 56 shown in FIG. 2. In one embodiment, a total load handling cost may be calculated as $818.98 and so block 700 directs the server processor 52 to set the total load handling time cost field 846 to $818.98.

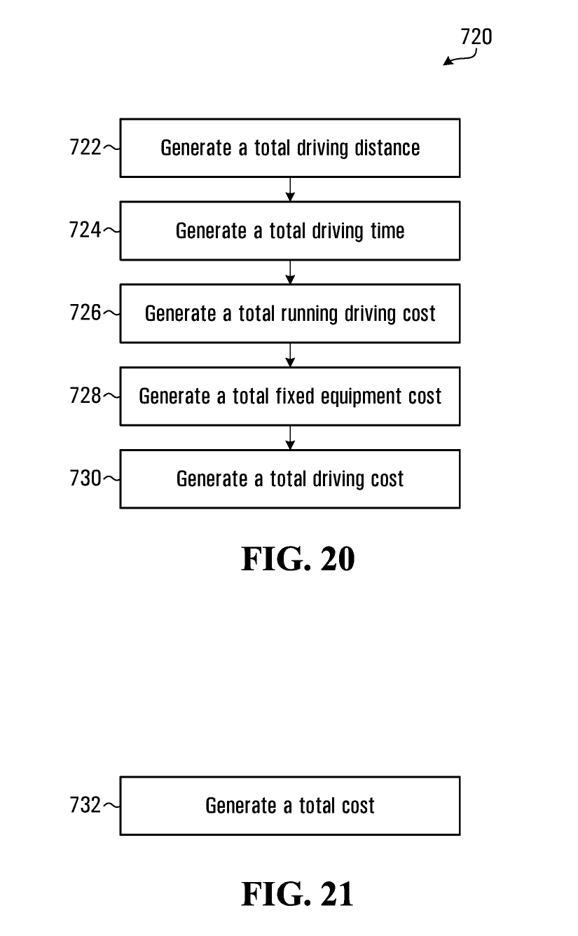

Referring to FIG. 20, a flowchart of blocks of code to be included in the block 404 of FIG. 13, in accordance with one embodiment, is shown generally at 720. The flowchart 720 directs the server processor 52 to generate travel summary information derived from at least one of the first feature information and the first load information included in the original transport information. In various embodiments, the travel summary information may include travel distance information and/or travel time information

The flowchart 720 begins with block 722 which directs the server processor 52 to generate a total driving distance by aggregating or summing driving distances included in the load information records included in the original transport information. For example, in one embodiment, block 722 may direct the server processor 52 to sum distances included in the driving distance fields of the load information records (e.g., including the driving distance field 532 of FIG. 12B and the driving distance field 582 of FIG. 12C) to generate the total driving distance.

In various embodiments, for example, block 722 may direct the server processor 52 to store the total driving distance in the total driving distance field 820 included in the derived information 800 shown in FIG. 14.

Block 724 of FIG. 20 then directs the server processor 52 generate a total driving time by aggregating or summing driving times included in the load information records included in the original transport information. For example, in one embodiment, block 724 may direct the server processor 52 to sum times included in the driving time fields of the load information records (e.g., including the driving time field 534 of FIG. 12B and the driving time field 584 of FIG. 12C) to generate the total driving time.

In various embodiments, for example, block 724 may direct the server processor 52 to store the total driving time in the total driving time field 822 included in the derived information 800.

Block 726 of FIG. 20 then directs the server processor 52 to generate a total fixed equipment driving cost based on the load information, the total fixed equipment driving cost acting as a travel cost. In some embodiments, block 726 may direct the server processor 52 to calculate the fixed equipment driving cost by multiplying the total driving distance by a fixed equipment rate. The fixed equipment rate may be provided by the user for example. In one embodiment, the fixed equipment rate is $0.75/mile and so in one embodiment the block 726 directs the server processor 52 to generate the total fixed equipment driving cost as the total driving distance multiplied by 0.75.

In various embodiments, block 726 may direct the server processor 52 to store the total fixed equipment driving cost in the total fixed equipment driving cost field 824 included in the derived information 800 shown in FIG. 14.

Block 728 of FIG. 20 then directs the server processor 52 to calculate a total running driving cost based on the load information, the total running driving cost acting as a travel cost. In some embodiments, block 728 may direct the server processor 52 to calculate the total running driving cost by multiplying the total driving distance by a running rate. The running rate may be provided by the user for example. In one embodiment, the running rate is $2.20/mile and so in one embodiment the block 726 directs the server processor 52 to generate the total running driving cost as the total driving distance multiplied by 2.20.

In various embodiments, block 728 may direct the server processor 52 to store the total running driving cost in the total running driving cost field 825 included in the derived information 800 shown in FIG. 14.

Block 730 of FIG. 20 then directs the server processor 52 to calculate a total driving cost by summing the total fixed equipment driving cost and the total running driving cost. Because the total driving cost is a function of other costs, the total driving cost acts as a composite cost. In various embodiments, block 730 may direct the server processor 52 to store the total driving cost in the total driving cost field 827 included in the derived information 800 shown in FIG. 14.

In various embodiments, block 404 of FIG. 13 may include block 732 as shown in FIG. 21 then directs the server processor 52 to calculate a total cost by summing the total layover cost, total pre-trip cost, total post-trip cost, total load handling time cost, total fixed equipment driving cost, and total running driving cost. Because the total cost is a function of other costs, the total cost acts as a composite cost. In various embodiments, for example, block 732 may direct the server processor 52 to store the total cost in the total cost field 862 included in the derived information 800 shown in FIG. 14.

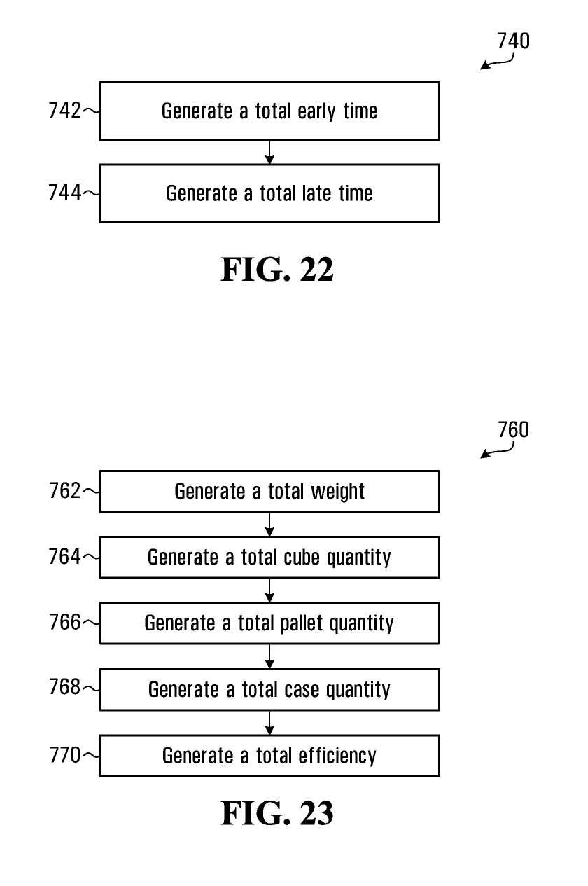

Referring to FIG. 22, a flowchart of blocks of code to be included in the block 404, in accordance with one embodiment, is shown generally at 740. The flowchart 740 directs the server processor 52 to generate time discrepancy information derived from at least one of the feature information and the load information included in the original transport information.

The flowchart 740 begins with block 742 which directs the server processor 52 to generate a total early time by aggregating or summing early times defined as differences between arrival times and availability windows associated with location identifier fields that identify locations that satisfy the early criterion, the total early time acting as time discrepancy information. For example, in an alternative embodiment to the one shown in FIG. 12B, the arrival time field 528 may be set to May 6, 2014, 10:30 am and so the location identifier field 358 is associated with feature and load information records that meet the early criterion. In such an embodiment, block 742 of FIG. 22 may direct the server processor 52 to calculate an early time as a difference between the arrival time represented by the arrival time field 528 and the availability window represented by the availability window field 527 as 11:00 am−10:30 am=30 minutes. Accordingly, block 742 may direct the server processor 52 to include in an aggregation or sum of differences between arrival times and availability windows, the difference of 30 minutes which is associated with the location identifier field 358.

In various embodiments, block 742 may direct the server processor 52 to store the total early time in the derived information, such as, in the total early time field 848 included in the derived information 800 shown in FIG. 14.

Block 744 of FIG. 22 then directs the server processor 52 to generate a total late time by aggregating or summing late times defined as differences between arrival times and availability windows associated with location identifiers that identify locations that satisfy the late criterion. For example, in an alternative embodiment to the one shown in FIG. 12B, the arrival time field 528 may be set to May 6, 2014, 3:30 pm and so the location identifier field 358 is associated with feature and load information that meets the late criterion. In such an embodiment, block 744 may direct the server processor 52 to calculate a late time or difference between the arrival time represented by the arrival time field 528 and the availability window represented by the availability window field 527 as 3:00 pm-3:30 pm=30 minutes. Accordingly, block 744 may direct the server processor 52 to include in an aggregation or sum of differences between arrival times and availability windows the difference of 30 minutes which is associated with the location identifier field 358 shown in FIG. 10.

In various embodiments, block 744 directs the server processor 52 to store the total late time in the total late time field 850 included in the derived information 800 shown in FIG. 14.

Referring to FIG. 23, a flowchart of blocks of code to be included in the block 404, in accordance with one embodiment, is shown generally at 760. The flowchart 760 directs the server processor 52 to generate summary load information derived from said load information included in the original transport information. In various embodiments, the summary load information may include a total weight, a total cube quantity, a total pallet quantity, a total case quantity, and/or a total efficiency, for example, and the flowchart 760 may include any or all of the blocks 762, 764, 766, 768, and 770.

The flowchart 760 begins with block 762 which directs the server processor 52 to generate a total weight by aggregating or summing location weights included in each load information record included in the original transport information. For example, in one embodiment, block 762 may direct the server processor 52 to sum location weight quantities (e.g. including the weight stored in the location weight field 560 shown in FIG. 12B) to generate the total weight.

In various embodiments, block 762 may direct the server processor 52 to store the total weight in the derived information, such as in the total weight field 852 included in the derived information 800 shown in FIG. 14.

Block 764 of FIG. 23 then directs the server processor 52 to generate a total cube quantity by aggregating or summing cube quantities included in the load information records included in the original transport information. Block 764 may be generally similar to block 762, but summing cube quantities instead of weight quantities. For example, in one embodiment, block 764 may direct the server processor 52 to sum location cube quantities (e.g. including the value stored in the location cube quantity field 562 shown in FIG. 12B) to generate the total cube quantity.

In various embodiments, block 764 may direct the server processor 52 to store the total cube quantity in the derived information, such as in the total cube quantity field 854 included in the derived information 800 shown in FIG. 14.

Block 766 of FIG. 23 then directs the server processor 52 to generate a total pallet quantity by aggregating or summing pallet quantities included in the load information records included in the original transport information. Block 766 may be generally similar to block 762, but summing pallet quantities instead of weight quantities. For example, in one embodiment, block 766 may direct the server processor 52 to sum location pallet quantities (e.g. including the value stored in the location pallet quantity field 564 shown in FIG. 12B) to generate the total pallet quantity.

In various embodiments, block 766 may direct the server processor 52 to store the total pallet quantity in the derived information, such as in the total pallet quantity field 856 included in the derived information 800 shown in FIG. 14.

Block 768 of FIG. 23 then directs the server processor 52 to generate a total case quantity by aggregating or summing case quantities included in the load information record included in the original transport information. Block 768 may be generally similar to block 762, but summing case quantities instead of weight quantities. For example, in one embodiment, block 768 may direct the server processor 52 to sum location case quantities (e.g. including the value of the location case quantity field 566 shown in FIG. 12B) to generate the total case quantity.

In various embodiments, block 768 may direct the server processor 52 to store the total case quantity in the derived information, such as in the total case quantity field 858 included in the derived information 800 shown in FIG. 14.

Block 770 of FIG. 23 then directs the server processor 52 to generate a total efficiency. In one embodiment, block 770 directs the server processor 52 to generate a total cube efficiency by dividing the total cube quantity by a total carrier cube capacity. In various embodiments, the total carrier cube capacity may be calculated by summing adjusted carrier capacities by volume associated with carrier identifiers included in the original transport information. The adjusted carrier capacities by volume may be retrieved, for example, from the adjusted carrier capacity information stored in location 106 of the variable memory 56 shown in FIG. 2, for example.

In various embodiments, block 770 directs the server processor 52 to store the total cube efficiency in the derived information as a percentage in the total cube efficiency field 860 included in the derived information 800 shown in FIG. 14.

In various embodiments, block 770 may direct the server processor 52 to generate a total weight efficiency in a generally similar manner as described above for generating a total cube efficiency.

In various embodiments, a user may be able to define different or additional fields that may be included in the derived information. For example, a user may define fields that are calculated as a function of other fields. In various embodiments, for example, a user may define additional or alternative composite cost fields storing values that are calculated as a sum of values stored in other cost fields.

In various embodiments, block 404 of FIG. 13 may include blocks of code that direct the server processor 52 to execute processes described above as being executed by the route generator. For example, blocks of code included in the block 404 may direct the server processor 52 to generate the values for the location weight fields, location cube quantity fields, location pallet quantity fields, location case quantity fields, load handling time fields, driving distance fields, driving time fields, arrival time fields, and/or departure time fields using generally the same processes described above with respect to the route generator. In such embodiments, these fields, though stored in the transport information, may act as derived information.

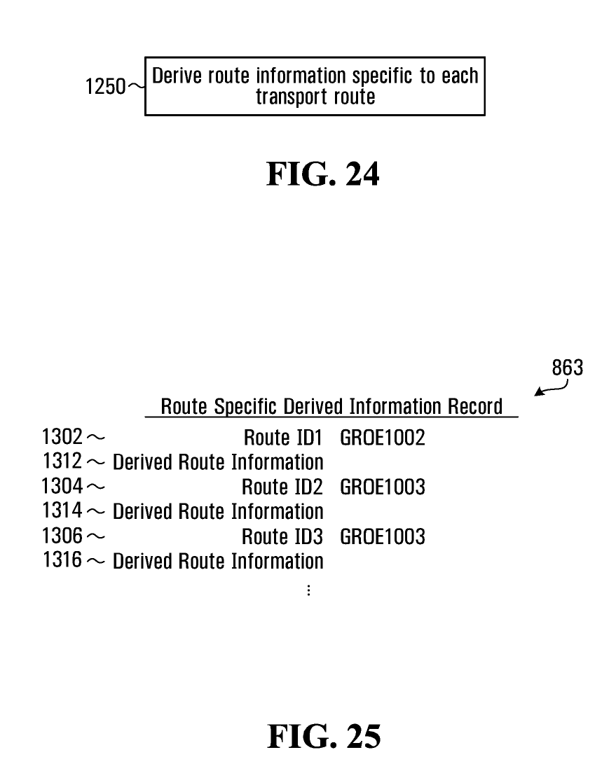

In various embodiments block 404 of FIG. 13 may include a block 1250 as shown in FIG. 24. Block 1250 may direct the server processor 52 to derive route information that is specific to each transport route record and store the derived route information in memory. In various embodiments, the derived route information may be stored in the route specific derived information record 863 included in the derived information 800 shown in FIG. 14, for example.

An exemplary representation of the route specific derived information record 863 in accordance with one embodiment is shown in FIG. 25. The route specific derived information record 863 includes a plurality of route identifier fields, which in the embodiment shown include route identifier fields 1302, 1304, and 1306, and derived route information records 1312, 1314, and 1316 associated with each of the route identifier fields. In various embodiments, the route identifiers stored in the route identifier fields included in the route specific derived information may correspond to route identifiers included in the transport route records included in the transport information from which the route specific derived information record 863 is derived.

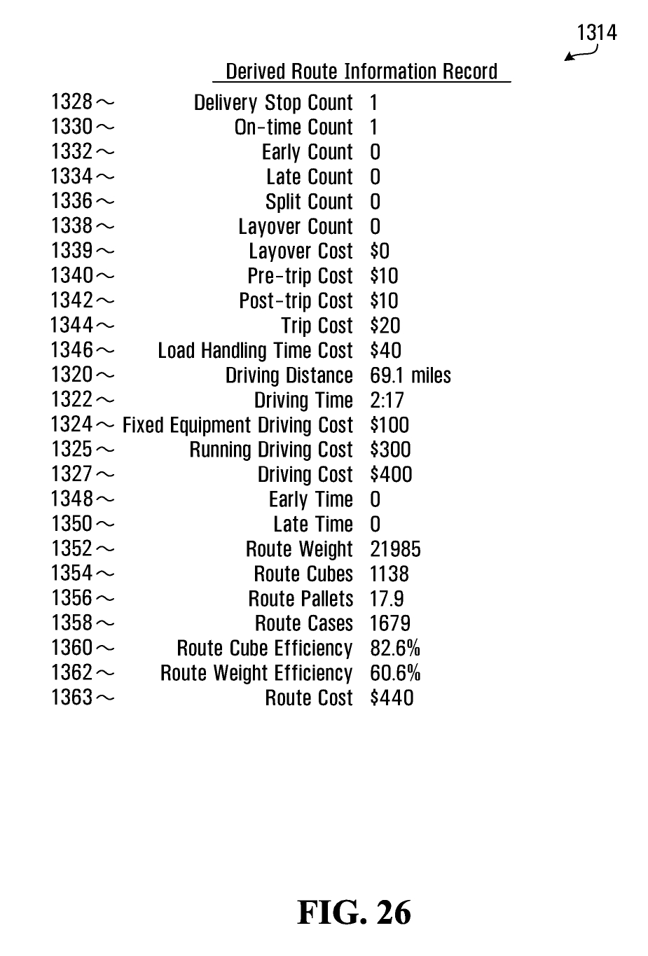

An exemplary embodiment of the derived route information record 1314 is shown in FIG. 26. Other derived route information records such as the derived route information records 1312 and 1316 may have a generally similar format to that of the derived information record 1314. In the embodiment shown, the derived route information record 1314 includes a route delivery stop count field 1328, a route on time count field 1330, a route early count field 1332, a route late count field 1334, a route split count field 1336, a route layover count field 1338, a route layover cost field 1339, a route pre-trip cost field 1340, a route post-trip cost field 1342, a route trip cost field 1344, a route load handling time cost field 1346, a route driving distance field 1320, a route driving time field 1322, a route fixed equipment driving cost field 1324, a route running driving cost field 1325, a route driving cost field 1327, a route early time field 1348, a route late time field 1350, a route weight field 1352, a route cube quantity field 1354, a route pallet quantity field 1356, a route case quantity field 1358, a route cube efficiency field 1360, a route weight efficiency field 1362, and a route cost field 1363.

Each of the above fields included in the derived route information record 1314 are for storing values that are derived based on at least one of the location identifier field, the feature information record and the load information record included in the transport route record that includes a route identifier that corresponds to the route identifier stored in the route identifier field 1304 associated with the derived route information record 1314.

Generally block 1250 of FIG. 24 may direct the server processor 52 to generate and store values for the above fields for each of the derived route information records in a generally similar way to that described above having regard to similar fields of the derived information 800 shown in FIG. 14. However, block 1250 directs the server processor 52 to generate each value based on the location identifiers, load information records, and feature information records included in a single transport route record, rather than based on all of the transport route records included in the transport information.

Referring to FIGS. 24 and 25, in various embodiments, block 1250 may direct the server processor 52 of FIG. 2 to derive a value for the route delivery stop count field 1328 by generating a count of location identifiers included in the transport route record 350 of FIG. 10 that satisfy the delivery stop criterion. Similarly, block 1250 may direct the server processor 52 to derive values for the route on time count field 1330, the route early count field 1332, the route late count field 1334, the route split count field 1336, and the route layover count field 1338 by generating counts of location identifiers included in the transport route record 350 that are associated with feature information and/or load information that satisfy the on time criterion, the early criterion, the late criterion, the split criterion, and the layover criterion respectively. Block 1250 may direct the server processor 52 to derive a value for the layover cost field 1339 by multiplying the route layover count by the cost per layover.

Block 1250 of FIG. 24 may direct the server processor 52 to derive values for the route pre-trip cost field 1340 and the route post-trip cost field 1342 by aggregating or summing pre-trip costs and post-trip costs respectively, which are included in the transport route record 350. Block 1250 may direct the server processor 52 to derive a value for the route trip cost field 1344 by summing the route post trip cost and the route pre-trip cost.

Block 1250 may direct the server processor 52 to derive a value for the route load handling time cost field 1346 by aggregating or summing load handling times included in the transport route record 350 and multiplying the sum by a load handling cost rate.

Block 1250 of FIG. 24 may direct the server processor 52 to derive a value for the route driving distance field 1320 and the route driving time field 1322 of FIG. 25 by aggregating or summing driving distances and driving times respectively, which are included in the transport route record 350 of FIG. 10. Block 1250 may direct the server processor 52 to derive a value for the route fixed equipment driving cost field 1324 and the running driving cost field 1325 by multiplying the distance stored in the route driving distance field by a fixed equipment rate and a running rate respectively. Block 1250 may direct the server processor 52 to derive a value for the route driving cost field 1327 by summing the values stored in the route fixed equipment driving cost field 1324 and the running driving cost field 1325.

Block 1250 may direct the server processor 52 to derive a value for the route early time field 1348, the route late time field 1350, the route weight field 1352, the route cube quantity field 1354, the route pallet quantity field 1356, and the route case quantity field 1358 by aggregating or summing early times, late times, location weight quantities, location cube quantities, location pallet quantities, and location case quantities respectively, from the transport route record 350

Block 1250 may direct the server processor 52 to derive a value for the route cube efficiency field 1360 by dividing the route cube quantity stored in the route cube quantity field 1354 by an adjusted carrier capacity by volume associated with a carrier identified by the carrier identifier stored in the carrier identifier field 354. Similarly, block 1250 may direct the server processor 52 to derive a value for the route weight efficiency field 1362 by dividing the route weight quantity stored in the route weight field 1352 by an adjusted carrier capacity by weight associated with a carrier identified by the same carrier identifier as is stored in the carrier identifier field 354. The carrier capacities may be retrieved, for example, from the adjusted carrier capacity information stored in location 106 of the variable memory.

Block 1250 may direct the server processor 52 to derive a value for the route cost field 1363 by summing the costs stored in the route layover cost field 1339, route trip cost field 1344, route load handling time cost field 1346 and route driving cost field 1327.

In various embodiments, total derived information included in the derived information 800 shown in FIG. 14 may be derived from the route specific derived information record 863. For example, in various embodiments, block 460 of FIG. 16 may direct the server processor 52 to generate the count of location identifiers included in the original transport information that are associated with feature information records and/or load information records that meet one of one or more location criteria by summing counts included in the route specific derived information. Blocks 462, 482, 484, 486, 700, 722, 724, 726, 728, 730, 732, 742, 744, 762, 764, 766, 768, and 770 of FIGS. 17-23 may similarly direct the server processor 52 to sum values stored in the route specific derived information in order to derive their respective derived information.

Referring back to FIG. 13, after block 404, the flowchart 400 continues at block 406. Block 406 directs the server processor 52 to produce signals for causing a display to display a representation of the current transport information stored in location 112 of the variable memory 56 shown in FIG. 2. In one embodiment block 406 directs the server processor 52 to retrieve the current transport information in location 112 of the variable memory 56 and send signals representing the current transport information to the client computer 14 to cause the display 130 of the client computer to display the current transport information.

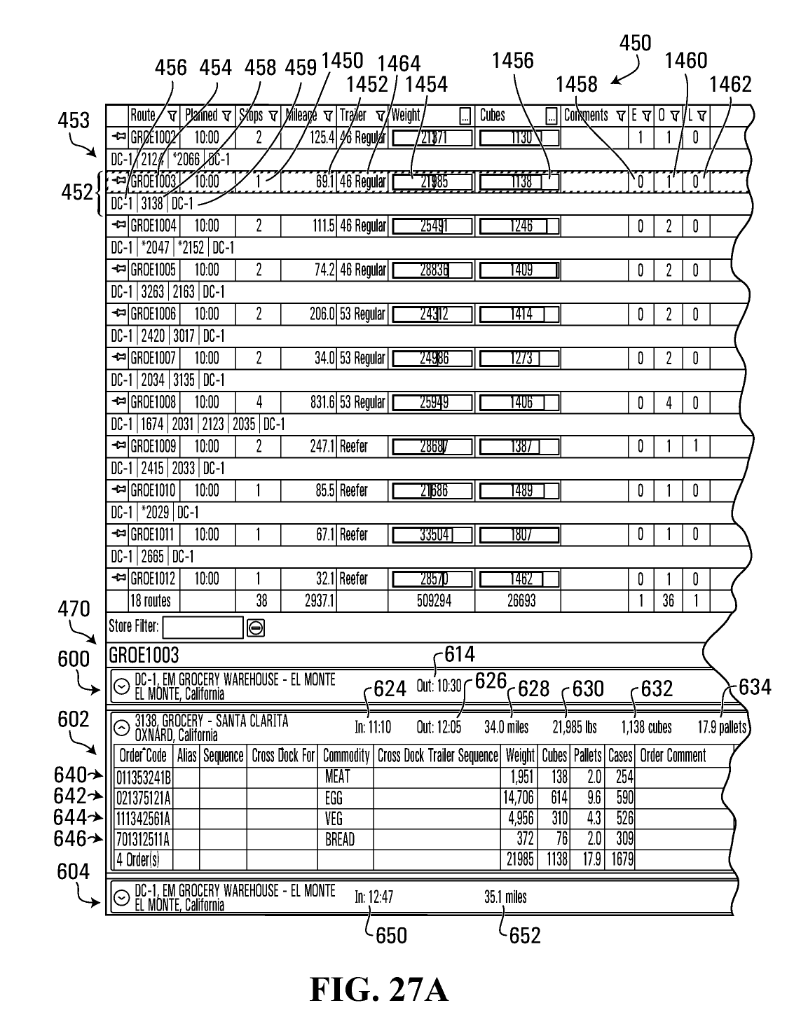

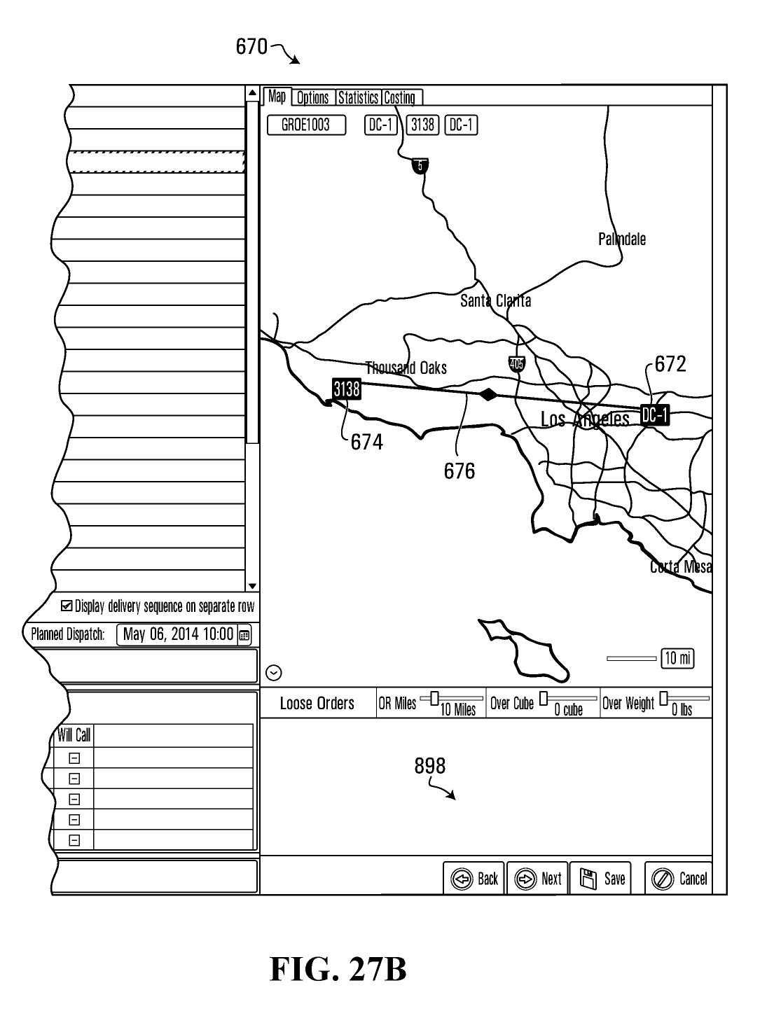

An exemplary display of the current transport information in accordance with one embodiment that may be depicted on the display 130 is shown at 450 in FIGS. 27A and 27B. The display 450 includes a route representation portion 453 for displaying rows that act as representations of transport route records included in the first transport information. In the embodiment shown, the first transport information includes the transport route record 350 shown in FIG. 10 and thus the display 450 shown in FIGS. 27A and 27B includes, in the route representation portion 453, rows 452 that act as a representation of the transport route record 350.

Referring to FIGS. 27A and 27B, in the embodiment shown, the rows 452 include a representation 454 of the value stored in the route identifier field 352 as shown in FIG. 10 and representations 456, 458, and 459 of the values stored in the location identifier fields 356, 358, and 360 shown in FIG. 10.

The rows 452 also include representations of some of the derived route information associated with the transport route record 350 shown in FIG. 10. For example, the rows 452 include a representation 1450 of the value stored in the route delivery stop count field 1328 of FIG. 26, and a representation 1452 of the value stored in the route driving distance field 1320 of FIG. 26. The rows 452 also include a representation 1454 of the values stored in the route weight field 1352 and the route weight efficiency field 1362 of FIG. 26. In the embodiment shown, the representation 1454 includes a percentage bar graph representing the value of the route weight efficiency field 1362 of FIG. 26, the percentage bar graph being a geometric figure that acts as a graphical representation of a comparison of the value stored in the route weight field 1352 of FIG. 26 and the capacity by weight of the carrier associated with the associated transport route record 350 shown in FIG. 10. Referring still to FIGS. 27A and 27B, the rows 452 include a similar representation 1456 of the values stored in the route cube quantity field 1354 and the route cube efficiency field 1360 of FIG. 26. In various embodiments, the representations 1454 and 1456 may facilitate quick scanning and assessing by a user of a plurality of routes being simultaneously displayed, to determine which routes are overloaded or close to overloaded (i.e., routes represented by transport route records including a total load quantity that is close to or greater than a carrier capacity).

The rows 452 also include representations 1458, 1460, and 1462 of the values stored in the route early count field 1332, the route on time count field 1330, and the route late count field 1334 of FIG. 26. In the embodiment shown, the rows 452 also include a representation 1464 of a load carrier type associated with the associated transport route record 350 of FIG. 10.

The other rows shown in FIGS. 27A and 27B include similar representations to those discussed above having regard to the rows 452.

In the embodiment shown in FIGS. 27A and 27B, the display 450 also includes a detailed route representation portion 470 for depicting further aspects of any transport route record associated with a selected row. In the embodiment shown, a user has selected the rows 452 representing the transport route record 350 of FIG. 10, such as by using a cursor of the user input devices 132. Accordingly, the detailed route representation 470 depicts further aspects of the transport route record 350.

The detailed route representation 470 shown in FIGS. 27A and 27B includes representations 600, 602, and 604 of the feature information records 366, 368 and 370 and the load information records 376, 378, and 380 associated with the location identifier fields 356, 358, and 360 of FIG. 10. In the embodiment shown, the representation 600 of the feature information record 366 and the load information record 370 includes a representation 614 of the value stored in the departure time field 542 of FIG. 12A.

Referring to FIGS. 27A, 27B and 12B, in the embodiment shown, the representation 602 includes a representation 624 of the value stored in the arrival time field 528, a representation 626 of the value stored in the departure time field 530, a representation 628 of the value stored in the driving distance field 532, a representation 630 of the value stored in the location weight field 560, a representation 632 of the value stored in the location cube quantity field 562, and a representation 634 of the value stored in the location pallet quantity field 564.

In the embodiment shown, the representation 602 has been selected by the user, and so additional detail for the selected representation 602 is also shown. The representation 602 includes representations 640, 642, 644, and 646 of the identifiers stored in the order identifier fields 552, 554, 556, and 558 and information stored in the order records 570, 572, 574, and 576 shown in FIG. 12B.

Referring to FIGS. 27A and 27B, the representation 604 includes a representation 650 of the time stored in the arrival time field 586 of the load information record 380 shown in FIG. 12C and a representation 652 of the distance stored in the driving distance field 582 of the load information record 380 shown in FIG. 12C.

In the embodiment shown in FIGS. 27A and 27B, the display 450 also includes a map portion 670 which depicts aspects of any transport route record associated with a selected row. As discussed above, in the embodiment shown, the user has selected the rows 452 representing the transport route record 350 shown in FIG. 10. Thus, the map portion 670 depicts aspects of the transport route record 350.

The map portion 670 includes representations 672 and 674 of the identifiers stored in the location identifier fields 356 and 360, and 358 of FIG. 10, which are shown on the map portion 670 in positions that correspond to the positions stored in the location position fields 506 and 526. The map portion 670 also includes a representation 676 of a path that may be taken between the locations identified by consecutive identifiers stored in the location identifier fields. In various embodiments, by viewing the map portion 670, a user may be able to more easily understand paths that must be taken by a carrier along any route represented by a selected transport route record.

Referring back to FIG. 13, after block 406 has finished, block 408 directs the server processor 52 to receive user input signals representing changes to the current transport information if such user input signals have been sent. In one embodiment, a user using the client computer 14 shown in FIG. 3 may execute code included in the block 140 to cause the client computer 14 to send to the server 12 the user input signals representing changes. For example, the user may use a cursor included in the user input devices 132 to drag and drop location identifiers and/or orders between various route representations displayed in the display 450 in order to make changes to the current transport information and the client computer 14 may send user input signals to the server 12 representing the changes.

Referring to FIG. 27B, for example, in one embodiment, the user may drag and drop location identifiers and/or orders to a loose order portion 898 of the display 450 and then select a different route representation. The user may then drag and drop the location and/or orders from the loose order portion 898 of the display 450 to a position in the now selected route representation. These actions may represent a change to the current transport information, and block 140 of FIG. 3 may direct the client processor 122 to send signals representing the change from the client computer 14 to the server 12. In various other embodiments, the user may make changes to the current transport information using other means.

The user input signals representing changes to the current transport information may include a representation of at least one amended transport route record and block 408 of FIG. 13 may direct the server processor 52 to receive the user input signals representing the at least one amended transport route record. In various embodiments, the at least one amended transport route record may have a generally similar format to the transport route records.

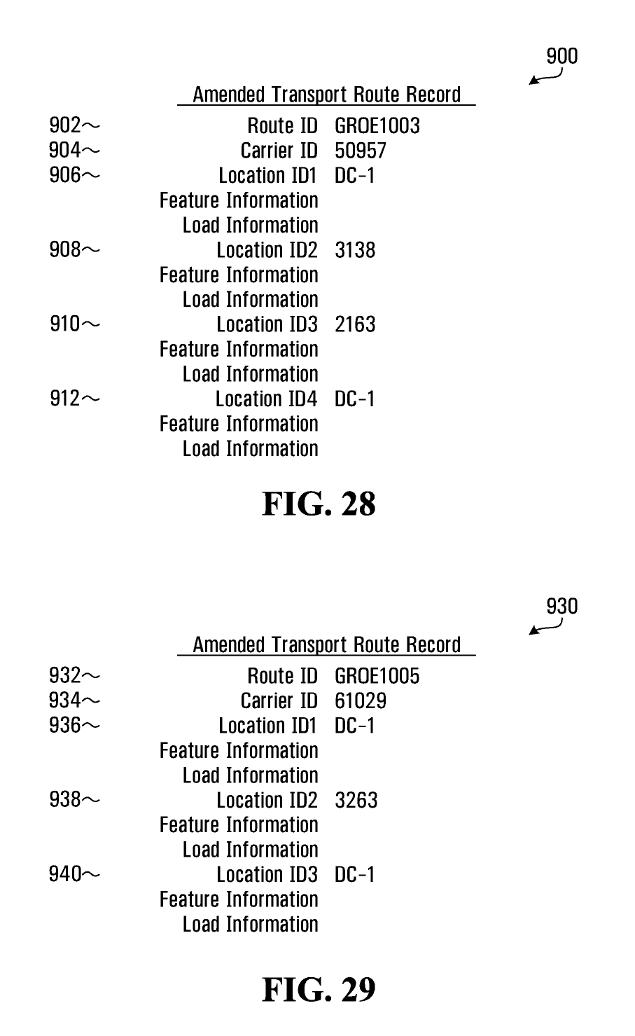

In one embodiment, block 408 directs the server processor 52 to receive signals representing amended transport route records such as exemplary amended transport route records 900 and 930 shown in FIGS. 28 and 29 respectively.

Referring to FIG. 28, the amended transport route record 900 includes a route identifier field 902 that is set to GROE1003 and thus corresponds to the identifier stored in the route identifier field 352 included in the transport route record 350 shown in FIG. 10. Therefore the amended transport route record 900 represents an amendment to the transport route record 350. The amended transport route record 900 also includes a carrier identifier field 904 set to 50957 and location identifier fields 906, 908, 910, and 912 set to DC-1, 3138, 2163, and DC-1 respectively. In the embodiment shown, the amended transport route record 900 also includes feature and load information records associated with each of the location identifier fields 906, 908, 910, and 912.

Referring to FIG. 29, the amended transport route record 930 has a format generally similar to the amended transport route record 900 and includes a route identifier field 932 that is set to GROE1005, a carrier identifier field 934 set to 61029, and location identifier fields 936, 938, and 940 set to DC-1, 3263, and DC-1 respectively.

Referring back to FIG. 13, if at block 408, the server processor 52 receives user input signals representing changes to the current transport information, the process continues at block 410 which directs the server processor 52 to generate updated transport information based on the received user input signals representing the changes to the current transport information. The updated transport information may act as second transport information and represent a second set of proposed transport routes. In various embodiments, block 410 may direct the server processor 52 to store the updated transport information as current transport information in location 112 of the variable memory 56.

For example, in one embodiment, where the received user input signals represent amended transport route records, block 410 may direct the server processor 52 to replace the transport route records in the current transport information that include the same route identifiers as included in the amended transport route records. In such embodiments, the server processor 52 may be considered to have generated the current transport information that includes the amended transport route records.

In various embodiments, block 410 may also direct the server processor 52 to update information included in the feature and/or load information of the amended transport route records 900 and 930 shown in FIGS. 28 and 29. For example, block 410 of FIG. 13 may direct the server processor 52 to generate updated values for location weight quantity, location cube quantity, location pallet quantity, location case quantity, load handling time, driving distance, driving time, arrival time and departure time, which are included in the amended transport route records 900 and 930 shown in FIGS. 28 and 29. The updated records may be generated using generally the same process used by the route generator to generate the original records.

Block 412 of FIG. 13 then directs the server processor 52 to derive information from at least one of the location identifiers, the feature information, and the load information included in the current transport information and store the derived information as current derived information in memory. In various embodiments, block 412 may include blocks of code for directing the server processor 52 to generate derived information generally similar to the blocks included in the block 404, except that block 412 directs the server processor 52 to derive the information from the current transport information that was generated by the server processor 52 at block 410. Block 412 directs the server processor 52 to store the derived information as current derived information in location 114 of the variable memory 56 shown in FIG. 2.

In various embodiments, where the derived information includes a route specific derived information record, when a change is made to transport route records included in the current transport information, block 412 of FIG. 13 may direct the server processor 52 to leave the derived route information records associated with unchanged transport route records unchanged, as these records need not be regenerated. This may facilitate faster generation of the derived information following a change to the current transport information.

Block 414 of FIG. 13 then directs the server processor 52 to produce signals for causing a display to display a representation of the current transport information. In one embodiment block 414 directs the server processor 52 to retrieve the current transport information from location 112 of the variable memory 56 shown in FIG. 2 and send signals representing the current transport information to the client computer 14 of FIG. 3 to cause the display 130 of the client computer to display the current transport information. Block 414 of FIG. 13 may be generally similar to the block 406.

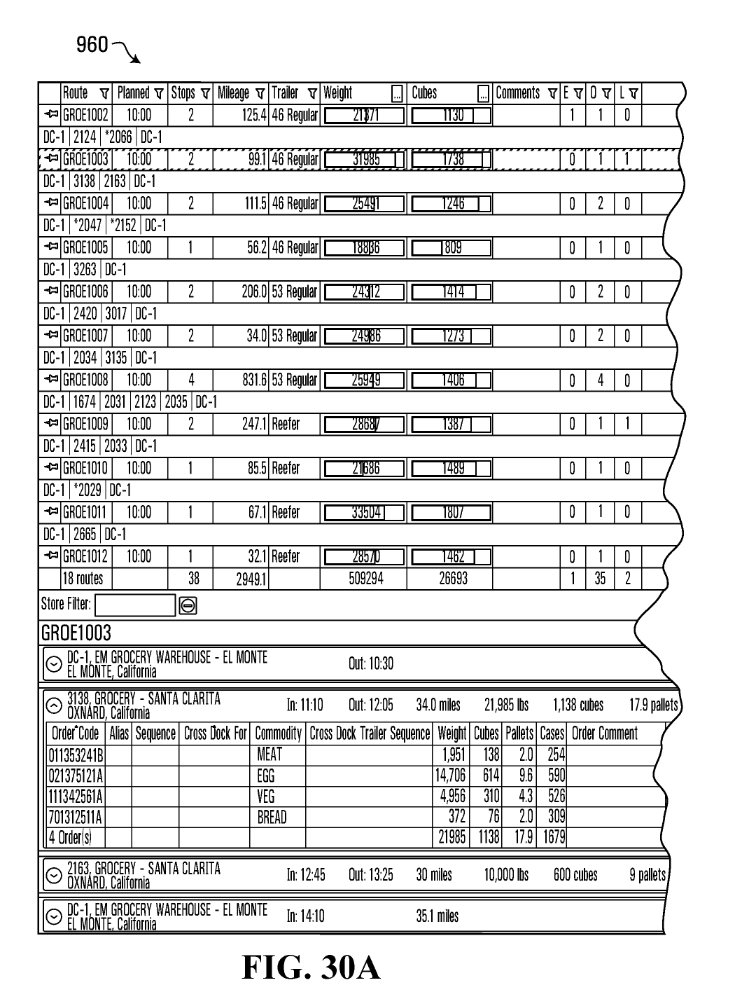

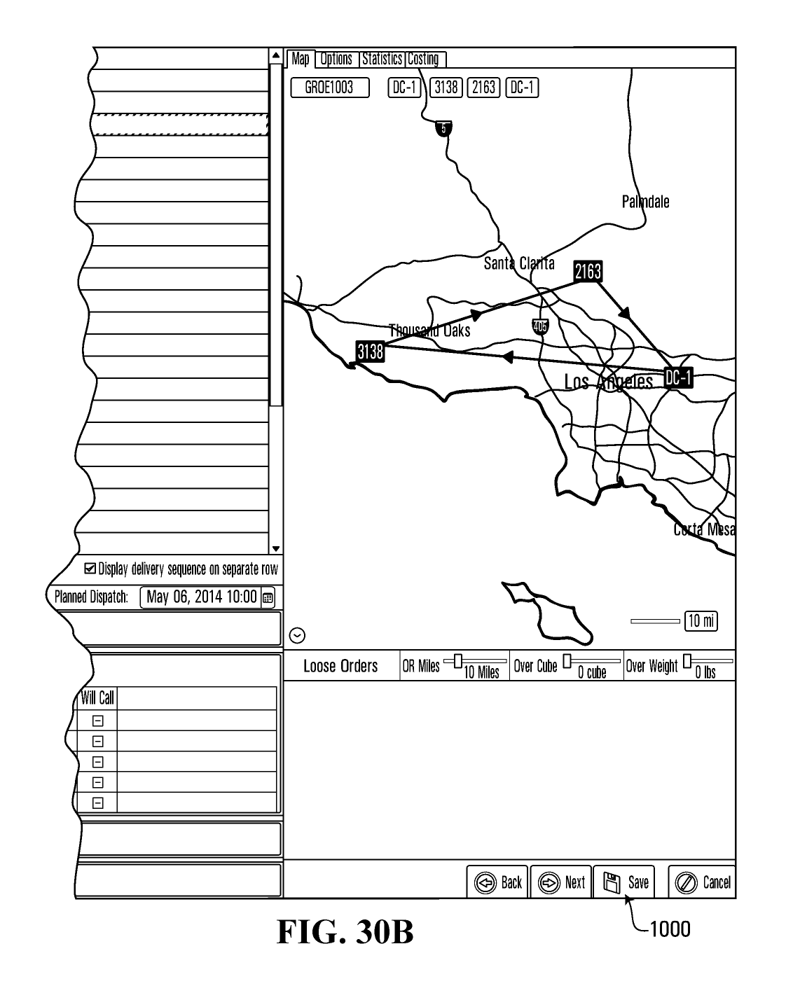

An exemplary display of the current transport information in accordance with one embodiment that may be depicted on the display 130 is shown at 960 in FIGS. 30A and 30B.

Referring to FIG. 13, in the embodiment shown, after block 414, or if at block 408 no user input signals defining changes to the current transport information have been received, the process continues at block 416. Block 416 directs the server processor 52 to receive signals indicating that the user wishes to save the current transport information if such signals have been sent and can be received. For example, referring to FIG. 30B, the user may select a save icon 1000 using a cursor included in the user input devices 132 and block 140 of FIG. 3 may direct the client computer 14 of FIG. 3 to, in response to the user's selection of the save icon 1000, send signals to the server 12 indicating that the user wishes to save the current transport information.

If at block 416 of FIG. 13, the server processor 52 receives signals indicating that the user wishes to save the current transport information, the process continues at block 418 which directs the server processor 52 to, in response to receiving the signals indicating that the user wishes to save the current transport information, store the current transport information as saved transport information in location 116 of the variable memory 56 shown in FIG. 2 and store the current derived information in location 118 of the variable memory 56 as saved derived information.

After block 418 of FIG. 13, or if at block 416 no signals indicating that the user wishes to save the current transport information have been received, the process continues at block 420. Block 420 directs the server processor 52 to produce signals for causing a display to display a representation comparing the original derived information, the current derived information and/or the saved derived information. In various embodiments, block 420 directs the server processor 52 to send signals to the client computer 14 of FIG. 3 for causing the display 130 of the client computer 14 to display a representation comparing the original derived information, the current derived information and/or the saved derived information.

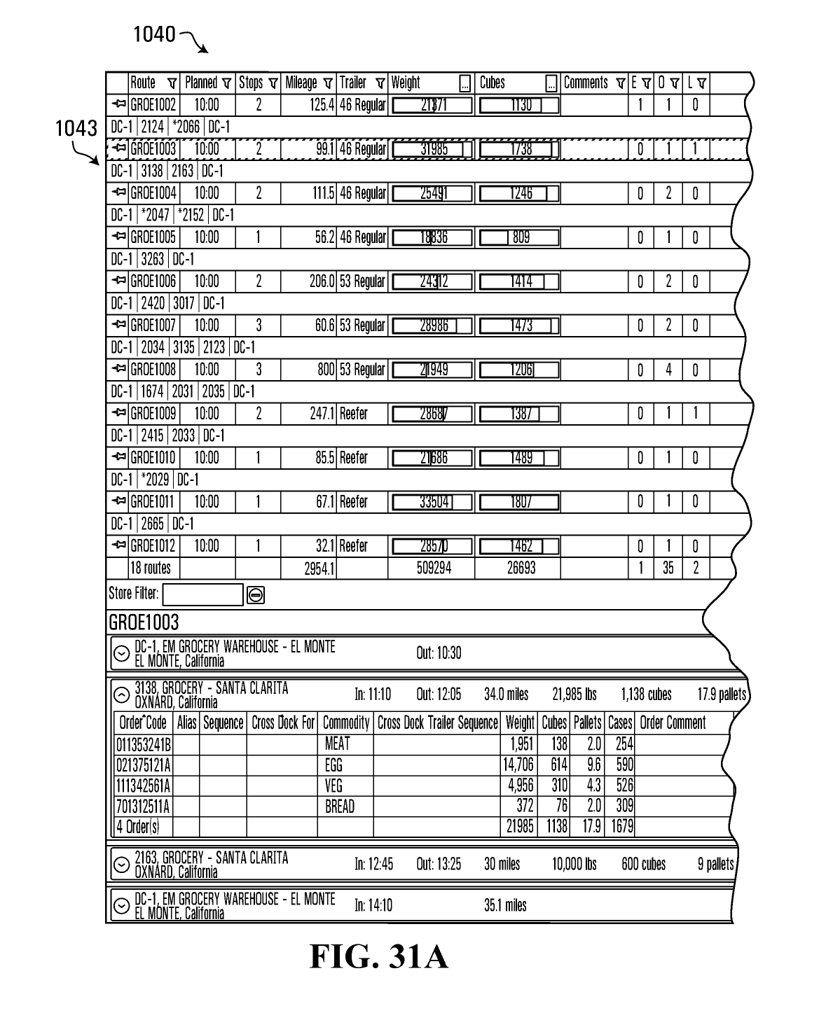

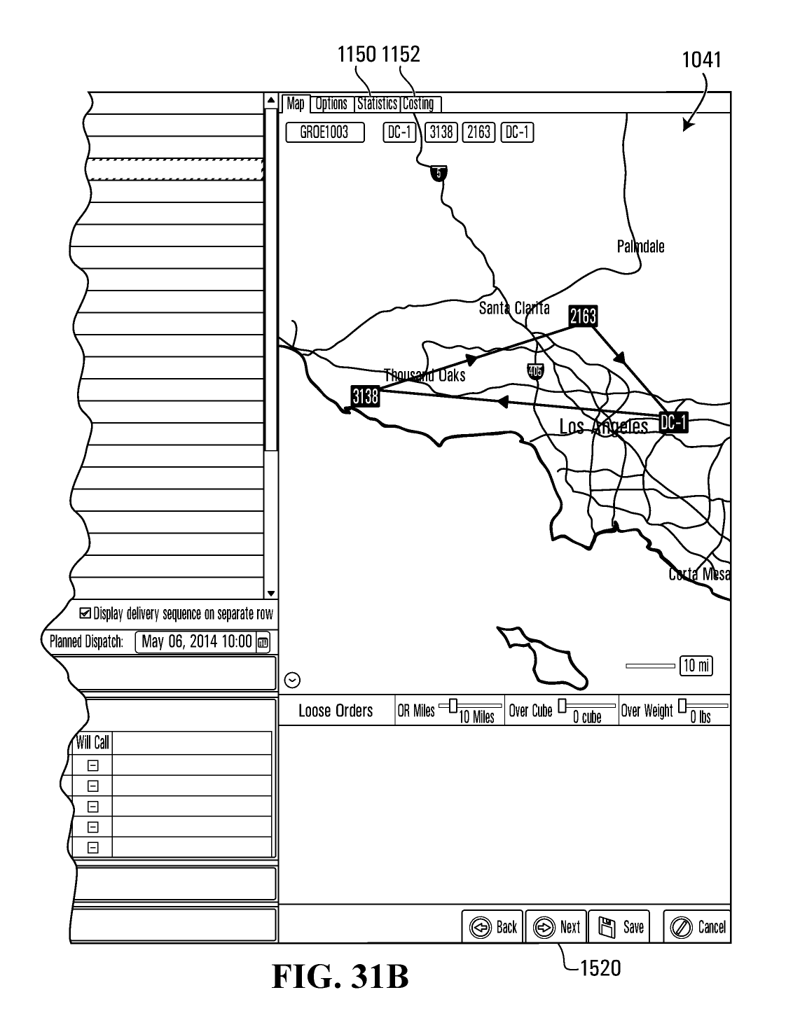

After block 420 of FIG. 13, the process returns to block 408 which again directs the server processor 52 to receive user input signals defining changes to the current transport information. For example, in one embodiment, the user may wish to make additional changes to the current transport information stored in location 114 of the variable memory 56 shown in FIG. 2 and block 408 may direct the server processor 52 to receive user input signals representing the additional changes to the second transport information stored as the current transport information in location 112 of the variable memory 56. Block 410 may then direct the server processor 52 to generate third transport information representing a third set of proposed third transport routes based on the received user input signals representing the changes to the second transport information. Block 410 may direct the server processor 52 to store the third transport information as the current transport information in location 112 of the variable memory 56 shown in FIG. 2. Block 412 of FIG. 13 may then direct the server processor 52 to derive third derived information from location identifiers, feature information, or load information included in the third transport information and to store the third derived information as the current derived information in location 114 of the variable memory 56. Block 414 may then direct the server processor 52 to send signals to the client computer 14 of FIG. 3 for causing the display 130 to display a representation of the current transport information. An exemplary display of third transport information stored as the current transport information in accordance with one embodiment is shown at 1040 in FIGS. 31A and 31B.

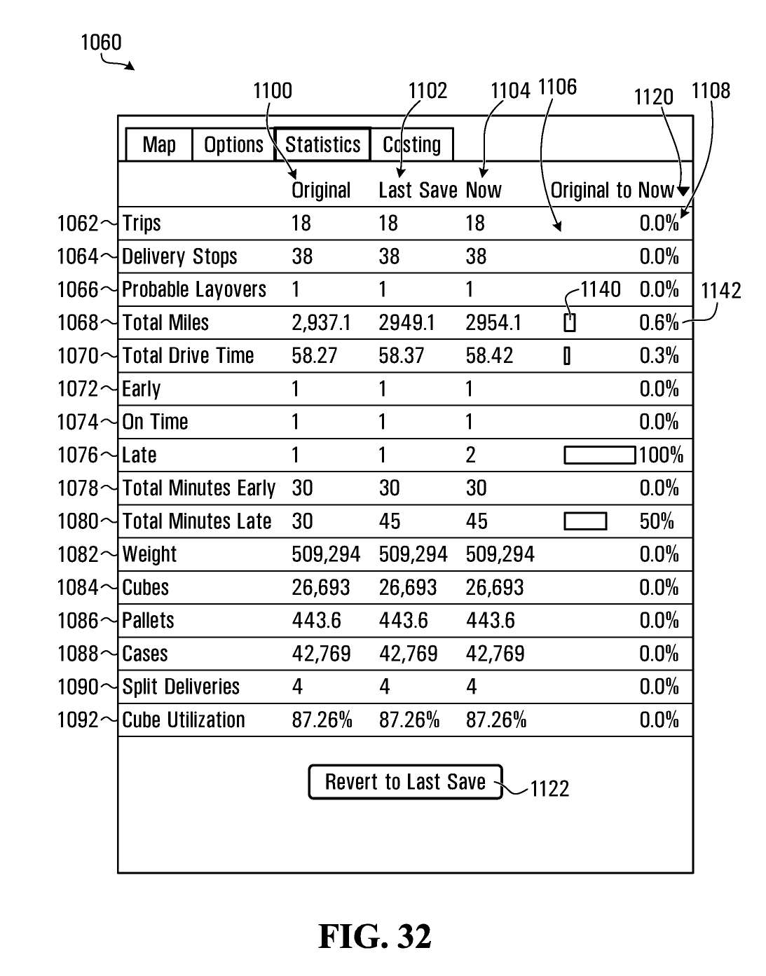

Referring to FIG. 13, in an exemplary embodiment such as the one described in the preceding paragraph, once the process returns to block 420, block 420 may direct the server processor 52 to produce signals for causing the display 130 of the client computer 14 of FIG. 3 to display a representation 1060 as shown in FIG. 32 comparing the original derived information, the current derived information and the saved derived information. For example, referring to FIG. 31B, block 420 of FIG. 13 may direct the server processor 52 to send signals to the client computer 14 to cause the display 130 to display the representation 1060 in a second region 1041 of the display 1040 in place of the map portion, when a user selects a statistics tab 1150. In various embodiments, the second region 1041 may be displayed concurrently with a first region 1043 of the display 1040 displaying a representation of the current transport information. In various embodiments, displaying the first and second regions 1043 and 1041 concurrently may facilitate easy review of the current transport information having regard to the representation comparing the derived information. In the embodiment shown, the first and second regions 1043 and 1041 are adjacent such that a user may be able to more easily compare the representations of the regions than if the regions were separated.

In various embodiments, displaying a representation comparing the derived information may allow a user to quickly see how a change to a subset of the routes, for example, a change to just one or two routes, affects or has affected statistics and/or costing of the routes as a whole.

In the embodiment shown in FIG. 32, the representation 1060 includes rows 1062-1092 and columns 1100, 1102, 1104, 1106, and 1108. Each of the rows 1062-1092 acts as a representation comparing a particular type of field value included in the columns 1100, 1102, and 1104. The values in the columns 1102, 1104, and 1106 represent values of fields included in the original derived information, the current derived information, and the saved derived information respectively.

Referring to FIGS. 32 and 14, row 1062 compares route count fields such as the route count field 826. Row 1064 compares total delivery stop count fields such as the total delivery stop count field 828. Row 1066 compares total layover count fields such as the total layover count field 838. Row 1068 compares total driving distance fields such as the total driving distance field 820. Row 1070 compares total driving time fields such as the total driving time field 822. Row 1072 compares total early count fields such as the total early count field 832. Row 1074 compares total on time count fields such as the total on time count field 830. Row 1076 compares total late count fields such as the total late count field 834. Row 1078 compares total early time fields such as the total early time field 848. Row 1080 compares total late time fields such as the total late time field 850. Row 1082 compares total weight fields such as the total weight field 852. Row 1084 compares total cube quantity fields such as the total cube quantity field 854. Row 1086 compares total pallet quantity fields such as the total pallet quantity field 856. Row 1088 compares total case fields such as the total case quantity field 858. Row 1090 compares total split count fields such as the total split count field 836. Row 1092 compares total cube efficiency fields such as the total cube efficiency field 860.

In various embodiments, block 420 of FIG. 13 may direct the server processor 52 to generate difference information representing at least one difference between the original derived information and the current derived information and include the difference information in the representation comparing the original derived information, the current derived information and/or the saved derived information.

In one embodiment, the difference information may include a percentage difference between a field value of the original derived information and a corresponding field value of the current derived information. Block 420 may direct the server processor 52 to generate difference information by dividing a field value included in the current derived information by a corresponding field value included in the original derived information and then subtracting 1, with the remaining value, expressed as a percentage, acting as the difference information. Block 420 may direct the server processor 52 to include at least one representation of the difference information in the representation comparing the original derived information and the current derived information. In the embodiment shown in FIG. 32, for example, block 420 of FIG. 13 has directed the server processor 52 to include graphic representations of difference information in column 1106, and numeric percentage representations of difference information in column 1108.

In various embodiments, the graphic representations include a bar having a width that varies proportionally with the value of the difference information that it represents. In some embodiments, the bar may be coloured according to whether the difference information is thought to indicate a good or a bad change (a good change usually meaning a decrease in costs). In one embodiment, a blue colour may indicate a good change and a red colour may indicate bad change. For example, in one embodiment, decreasing total driving distance may be considered good and therefore driving distance difference information that indicates a decrease in total driving distance may be represented by a blue bar and driving distance difference information that indicates an increase in total driving distance may be represented by a red bar.

For example, referring to the row 1068 shown in FIG. 32, the current derived information stored in location 114 of the variable memory 56 shown in FIG. 2 includes a total driving distance field set to 2954.1 and the original derived information stored in location 110 includes a total driving distance field set to 2937.1 and so block 420 of FIG. 13 directs the server processor 52 to generate total driving distance difference information as 2954.1/2937.1−1, which is equal to +0.6%. Block 420 directs the server processor 52 to include in the representation 1060 a red bar 1140 and a numeric value 1142 representing the total driving distance difference information of +0.6%.

In the embodiment shown in FIG. 32, the columns 1106 and 1108 include representations of difference information representing a difference between the current derived information and the original derived information. In one embodiment, a user may be able to select, using the user input devices 132 of the client computer 14 shown in FIG. 3, from the options, “Original to Now”, “Original to Saved” and “Saved to Now” shown in a drop down menu which appears when the user selects arrow 1120. The user's selection may cause block 420 of FIG. 13 to direct the server processor 52 to cause the columns 1106 and 1108 to represent a corresponding difference. For example, the embodiment shown in FIG. 32 may be displayed when “Original to Now” has been selected.

In various embodiments, when “Original to Saved” has been selected, block 420 of FIG. 13 directs the server processor 52 to generate difference information representing at least one difference between the original derived information and the saved derived information and columns 1106 and 1108 may represent the difference information. Similarly, when “Saved to Now” has been selected, block 420 of FIG. 13 directs the server processor 52 to generate difference information representing at least one difference between the saved derived information and the current derived information and columns 1106 and 1108 may represent the difference information.

In various embodiments, the representation 1060 of FIG. 32 may include a subset of the columns 1100, 1102, 1104, 1106, and 1108. For example, in one embodiment, for example, blocks 416 and 418 may be omitted from the flowchart 400 of FIG. 13 and thus the user may be unable to save the transport information. In such an embodiment, the representation 1060 of FIG. 32 may omit the column 1102. In another embodiment, for example, the representation 1060 comparing the derived information may omit the columns 1106 and/or 1108.

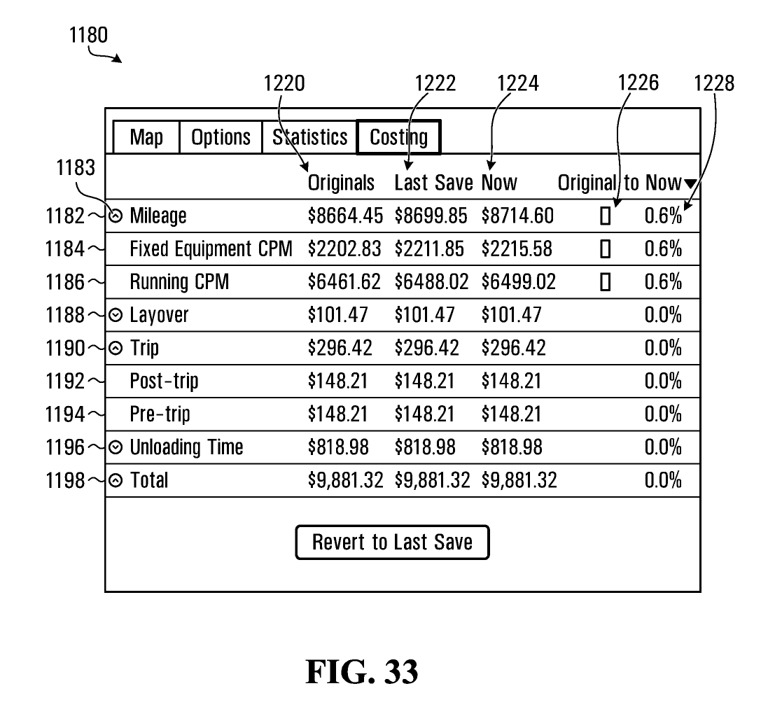

In various embodiments, block 420 of FIG. 13 may also direct the server processor 52 to produce signals for displaying a representation 1180 as shown in FIG. 33 comparing additional records included in the original derived information, the current derived information and the saved derived information. For example, referring to FIG. 31B, the representation 1180 may be displayed in the second region 1041 of the display 1040 when a user selects a costing tab 1152. The representation 1180 may be generally similar to the representation 1060, except that the derived information shown in the representation 1180 is related to costs.

Referring to FIG. 33, the representation 1180 includes rows 1182-1198 and columns 1220, 1222, 1224, 1226, and 1228. Each of the rows 1182-1198 acts as a representation comparing a particular type of field value included in the columns 1220, 1222, and 1224. The values in the columns 1220, 1222, and 1224 represent values of fields included in the original derived information, the current derived information, and the saved derived information respectively.

Referring to FIGS. 33 and 14, row 1182 compares total driving cost fields such as the total driving cost field 827 of FIG. 14. Row 1184 compares total fixed equipment driving cost fields such as the total fixed equipment driving cost field 824. Row 1186 compares total running driving cost fields such as the total running driving cost field 825. Row 1188 compares total layover cost fields such as the total layover cost field 839. Row 1190 compares total trip cost fields such as the total trip cost field 844. Row 1192 compares total post-trip cost fields such as the total post-trip cost field 842. Row 1194 compares total pre-trip cost fields such as the total pre-trip cost field 840. Row 1196 compares total load handling time cost fields such as the total load handling time cost field 846. Row 1198 compares total cost fields such as the total cost field 862.

In the embodiment shown, because the rows 1182, 1190 and 1198 of FIG. 33 compare composite costs, these rows may be displayed in expanded form or reduced form. In expanded form, rows comparing costs included in the composite costs are shown. In reduced form, rows comparing costs included in the composite costs are not shown. A user may switch between expanded and reduced form by selecting an arrow icon included in the row showing the composite costs (i.e., arrow icon 1183). For example, if a user selected the arrow icon 1183, block 140 of FIG. 3 may direct the client processor 122 to send a signal to the server 12 and block 420 may direct the server processor 52 to, in response to receiving the signal, cause the representation 1180 of FIG. 33 to no longer display the rows 1184 and 1186.

Column 1226 includes graphic representations of difference information and column 1228 includes numeric percentage representations of difference information.

In various embodiments, the representations 1060 or 1180 may be combined as a single representation. In various embodiments, the representation 1060 or 1180 or a combined representation may be displayed in the second region 1041 of the display 1040.

In various embodiments, by displaying the representations 1060 and/or 1180 in the display 1040, adjacent to representations of the current transport information, which a user can make changes to, a user may be able to quickly and easily see how changes to the current transport information affect the derived information.

In various embodiments, displaying representations comparing original, saved, and current derived information concurrently may facilitate recognition by a user of how the transport information has evolved from an original state through an intermediary state to a current state.

In various embodiments, a user may wish to undo changes to the current transport information that were made after the transport information was last stored as saved transport information and display the saved transport information. For example, referring back to FIG. 32, a user may notice that the column 1102 depicts derived information that the user considers more desirable than derived information depicted by the column 1104, or, for example, the user may have caused the columns 1106 and 1108 to represent differences between the saved derived information and the current derived information and the user may notice that the differences displayed by columns 1106 and 1108 are not desirable. In such cases, the user may wish to undo changes to the current transport information and display the saved transport information.

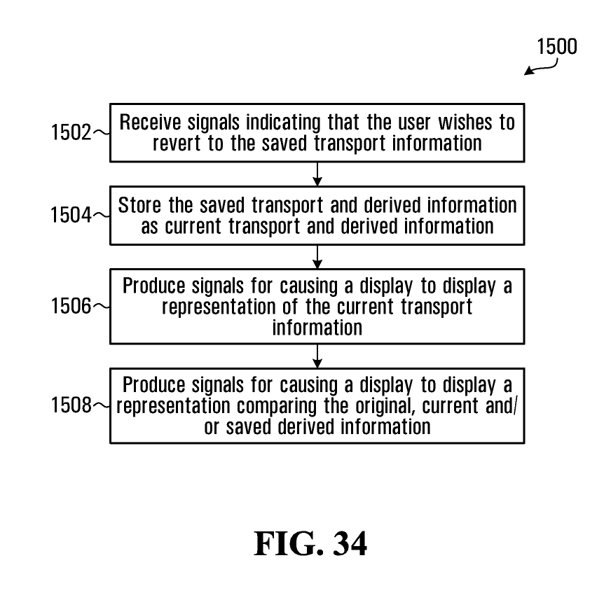

FIG. 34 depicts a flowchart 1500 of blocks of code, in accordance with one embodiment, that may be included in the flowchart 400 shown in FIG. 13. The flowchart 1500 may be executed after block 420 of FIG. 13, for example. The flowchart 1500 generally directs the server processor 52 to facilitate reverting to saved information functions.

The flowchart 1500 begins with block 1502 which directs the server processor 52 to receive signals indicating that a user wishes to revert to saved transport information. In the embodiment shown in FIG. 32, for example, a user may select a Revert to Last Save icon 1122 and, in response to the selection of the icon 1122, block 140 of FIG. 3 may direct the client computer 14 to send signals to the server 12 indicating that the user wishes to display the saved transport information. The signals may be received by the server processor 52 at block 1502 of the flowchart 1500 shown in FIG. 34.

Block 1504 of FIG. 34 then directs the server processor 52 to retrieve the saved transport information from location 116 of the variable memory 56 of FIG. 2 and store the saved transport information as the current transport information in location 112. In various embodiments, block 1504 also directs the server processor to retrieve the saved derived information from location 118 of the variable memory 56 and store the saved derived information as the current derived information in location 114

Block 1506 of FIG. 34 directs the server processor 52 to produce signals for causing a display to display a representation of the current transport information stored in location 112 of the variable memory 56 of FIG. 2. In various embodiments, block 1506 may be generally similar to the block 406 shown in FIG. 13.

Block 1508 of FIG. 34 then directs the server processor 52 to produce signals for causing a display to display a representation comparing the original, current, and/or saved derived information stored in the locations 112, 116, and 119 of the variable memory 56 of FIG. 2. In various embodiments, block 1508 may be generally similar to the block 420 shown in FIG. 13.

In various embodiments, execution of the flowchart 1500 may allow a user of the client computer 14 to easily undo changes that have been made following a save, if, for example, the user notices that the derived information associated with the current transport information is not desirable when compared to the derived information associated with the saved transport information.

In view of the foregoing, the process depicted by the flowchart 400 may allow a user to make numerous changes to the current transport information and/or the saved transport information, and to quickly see the changes and how they affect the derived information.

When the user is finished amending the current transport information stored in location 114 of the variable memory 56 shown in FIG. 2, the user may wish to store the transport information as final transport information, which can then be exported or sent by the server 12 to a dispatch computer, warehouses and/or operators (e.g. drivers) of load carriers identified by the final transport information to direct the warehouses and/or operators to execute the routes represented by the final transport information.

For example, in various embodiments, when the user is happy with the current transport information displayed, the user may select a next icon (1520 shown in FIG. 31B, for example), to cause block 140 of FIG. 3 to direct the client processor 122 to send signals to the server 12 indicating that the user wishes to store the current transport information as final transport information.

Upon receiving the signals indicating that the user wishes to store the current transport information as final transport information, a block of code stored in the block of codes 84 shown in FIG. 2 may direct the server processor 52 to store the current transport information in location 119 of the variable memory 56 as final transport information. In various embodiments, the final transport information may be reloaded as first transport information, for further amending using the flowchart 400 shown in FIG. 13, for example, at a later time.

When the user wishes to cause the final transport information to be exported, the user may use the user input devices 132 to interact with a user interface, for example, to cause the block 140 of FIG. 3 to direct the client processor 122 to send signals to the server 12 indicating that the user wishes to export the final transport information. Upon receiving the signals indicating that the user wishes to export the final transport information, codes included in the block of code stored in location 86 of the program memory 54 shown in FIG. 2 may direct the server 12 to send signals representing at least a portion of the final transport information through the I/O interface 58 over the network 18 to one or more warehouses identified by the final transport information to allow the warehouses to prepare loads for transport.

When a user wishes to dispatch load carriers, the user may use a dispatch computer connected to the network 18, such as, for example, the client computer 14, to cause representations of the routes included in the final transport information stored in the location 119 of the variable memory 56 shown in FIG. 2 to be displayed. The user may then use the information to assign load carriers and operators of the load carriers to the routes. For example, in one embodiment, a user may cause the block 140 of the program memory 124 shown in FIG. 3 to direct the client processor 122 to send signals to the server 12 for causing the server 12 to retrieve the final transport information stored in the location 119 and send the final transport information to the client processor 122 for display by the display 130 shown in FIG. 3.

In one embodiment, a user may read the displayed information and assign load carriers and operators of the load carriers to the routes by communicating to the operators verbally, for example. In various embodiments, the user may provide the operators with a print out of a route to which they are assigned by causing block 140 of FIG. 3 to direct the client processor 122 to send signals representing a route represented by the final transport information to a printer (not shown). The operators may then use the load carriers to execute the routes.

In another embodiment, the operators themselves may use a dispatch computer connected to the network 18, such as, for example, a computer similar to the client computer 14, to cause representations of the routes included in the final transport information stored in the location 119 of the variable memory 56 shown in FIG. 2 to be displayed. The operators may then each assign themselves to a route, print out a representation of the route, and use an appropriate load carrier to execute the route.

While specific embodiments of the invention have been described and illustrated, such embodiments should be considered illustrative of the invention only and not as limiting the invention as construed in accordance with the accompanying claims.

1. A computer-implemented method of facilitating display of information to a user for use in planning transport routes, the method comprising:
causing at least one processor to receive signals representing first transport information representing a first set of proposed first transport routes, each first transport route having one or more first locations associated therewith, wherein said first transport information includes, for each of the first locations, a first location identifier and associated first feature information and first load information, wherein said first transport routes are represented by respective sets of said first location identifiers;
causing the at least one processor to produce signals for causing a display to display a representation of the first transport information;
causing the at least one processor to derive and store in memory first derived information derived from at least one of:
said first location identifiers,
said first feature information, and
said first load information;
causing the at least one processor to receive user input signals representing changes to the first transport information;
causing the at least one processor to generate second transport information representing a second set of proposed second transport routes based on the received user input signals defining said changes to the first transport information, each second transport route having one or more second locations associated therewith, wherein said second transport information includes, for each of the second locations, a second location identifier and associated second feature information and second load information, wherein said second transport routes are represented by respective second sets of said second location identifiers;
causing the at least one processor to produce signals for causing the display to display a representation of the second transport information;
causing the at least one processor to derive second derived information derived from at least one of:
said second location identifiers,
said second feature information, and
said second load information; and
causing the at least one processor to produce signals for causing the display to display a representation comparing the first derived information with the second derived information.

2. The method of claim 1 further comprising:
causing the at least one processor to receive user input signals representing changes to the second transport information;
causing the at least one processor to generate third transport information representing a third set of proposed third transport routes based on the received user input signals representing said changes to the second transport information, each third transport route having one or more third locations associated therewith, wherein said third transport information includes, for each of the third locations, a third location identifier and associated third feature information and third load information, wherein said third transport routes are represented by respective third sets of said third location identifiers;
causing the at least one processor to produce signals for causing the display to display a representation of the third transport information;
causing the at least one processor to derive third derived information derived from at least one of:
said third location identifiers,
said third feature information, and
said third load information; and
causing the at least one processor to produce signals for causing the display to display a representation comparing at least one of the first and second derived information with the third derived information.

3. The method of claim 2 wherein the representation comparing the first derived information with the second derived information and the representation comparing the at least one of the first and second derived information with the third derived information are displayed concurrently.

4. The method of claim 1 further comprising:
causing the at least one processor to receive signals indicating that the user wishes to save the second transport information;
causing the at least one processor to, in response to receiving said signals indicating that the user wishes to save the second transport information, store said second transport information in the memory as saved transport information and store said second derived information in the memory as saved derived information

5. The method of claim 4 further comprising:
causing the at least one processor to receive signals indicating that the user wishes to display the saved transport information;
causing the at least one processor to, in response to receiving said signals indicating that the user wishes to display the saved transport information, retrieve the saved transport information from the memory and produce signals for causing the display to display a representation of the saved transport information.

6. The method of claim 1 wherein causing the at least one processor to produce signals for causing the display to display the representation of the second transport information comprises causing the at least one processor to produce signals for causing the display to display the representation of the second transport information in a first region of the display and wherein causing the at least one processor to produce signals for causing the display to display the representation comparing the first derived information with the second derived information comprises causing the at least one processor to produce signals for causing the display to display the representation comparing the first derived information with the second derived information in a second region of the display concurrently with the representation of the second transport information.

7. The method of claim 6 wherein said second region of the display is adjacent to the first region of the display.

8. The method of claim 1 further comprising causing the at least one processor to generate difference information representing at least one difference between the first and second derived information and wherein the representation comparing the second derived information with the first derived information comprises a representation of the difference information.

9. The method of claim 8 wherein the difference information comprises at least one percentage difference between values of the first and second derived information.

10. The method of claim 8 wherein the representation of the difference information includes a graphic.

11. The method of claim 10 wherein the graphic comprises a geometric figure.

12. The method of claim 1 wherein causing the at least one processor to derive said second derived information comprises causing the at least one processor to derive and store in the memory, respective derived route information associated with each respective set of said at least one set of second location identifiers, wherein each said respective derived route information is derived from at least one of:
said second location identifiers,
said second feature information, and
said second load information.

13. The method of claim 12 wherein the second derived information comprises a representation of at least one aggregation of said respective derived route information.

14. The method of claim 1 wherein causing the at least one processor to derive said first derived information comprises causing the at least one processor to generate a first route count of said sets of said first location identifiers, said first derived information including said first route count, and wherein causing the at least one processor to derive said second derived information comprises causing the at least one processor to generate a second route count of said second sets of said second location identifiers, said second derived information including said second route count.

15. The method of claim 1 wherein:
causing the at least one processor to derive said first derived information comprises causing the at least one processor to generate at least one first location count, each first location count representing a count of said first location identifiers that are associated with first feature information or first load information that meets at least one of one or more location criteria, said first derived information including said at least one first location count; and
causing the at least one processor to derive said second derived information comprises causing the at least one processor to generate at least one second location count, each second location count representing a count of said second location identifiers that are associated with second feature information or second load information that meets at least one of the one or more location criteria, said second derived information including said at least one second location count.

16. The method of claim 15 wherein the one or more location criteria comprises a delivery stop criterion.

17. The method of claim 15 wherein the one or more location criteria comprises an early delivery criterion.

18. The method of claim 15 wherein the one or more location criteria comprises an on time criterion.

19. The method of claim 15 wherein the one or more location criteria comprises a late criterion.

20. The method of claim 15 wherein the one or more location criteria comprises a split criterion.

21. The method of claim 15 wherein the one or more location criteria comprises a layover criterion.

22. The method of claim 21 wherein causing the at least one processor to derive said first derived information comprises causing the at least one processor to generate first layover costs based on said at least one first location count and wherein causing the at least one processor to derive said second derived information comprises causing the at least one processor to generate second layover costs based on said at least one first location count, said first and second derived information including said first and second layover costs respectively.

23. The method of claim 1 wherein:
causing the at least one processor to derive said first derived information comprises causing the at least one processor to generate a first trip cost based on at least one of said first feature information and said first load information;
causing the at least one processor to derive said second derived information comprises causing the at least one processor to generate a second trip cost based on at least one of said second feature information and said second load information.

24. The method of claim 23 wherein said first derived information includes said first trip cost and said second derived information includes said second trip cost.

25. The method of claim 23 wherein the first and second trip costs comprise first and second pre-trip costs.

26. The method of claim 23 wherein the first and second trip costs comprise first and second post-trip costs.

27. The method of claim 1 wherein:
causing the at least one processor to derive said first derived information comprises causing the at least one processor to generate a first load handling time cost based on said first load information;
causing the at least one processor to derive said second derived information comprises causing the at least one processor to generate a second load handling time cost based on said second load information.

28. The method of claim 27 wherein said first derived information includes said first load handling time cost and said second derived information includes said second load handling time cost.

29. The method of claim 1 wherein causing the at least one processor to derive said first derived information comprises causing the at least one processor to generate first travel summary information derived from at least one of said first feature information and said first load information and wherein causing the at least one processor to derive said second derived information comprises causing the at least one processor to generate second travel summary information derived from at least one of said second feature information and said second load information.

30. The method of claim 29 wherein said sets of said first location identifiers and said sets of said second location identifiers are ordered sets and wherein:
said first travel summary information comprises an aggregation of first travel branch information associated with consecutive first location identifiers, said first travel branch information derived from first position information included in the first feature information associated with said consecutive first location identifiers; and
said second travel summary information comprises an aggregation of second travel branch information associated with consecutive second location identifiers, said second travel branch information derived from second position information included in the second feature information associated with said consecutive second location identifiers.

31. The method of claim 30 wherein said first and second travel summary information comprise first and second distance information respectively.

32. The method of claim 30 wherein said first and second travel summary information comprise first and second time information respectively.

33. The method of claim 30 wherein said first and second derived information include said first and second travel summary information respectively.

34. The method of claim 30 wherein causing the at least one processor to derive said first derived information comprises causing the at least one processor to generate a first travel cost based on said first travel summary information and wherein causing the at least one processor to derive said second derived information comprises causing the at least one processor to generate a second travel cost based on said second travel summary information and wherein said first and second derived information include said first and second travel costs respectively.

35. The method of claim 1 wherein:
causing the at least one processor to derive said first derived information comprises causing the at least one processor to generate first time discrepancy information derived from at least one of said first feature information and said first load information; and
causing the at least one processor to derive said second derived information comprises causing the at least one processor to generate second time discrepancy information derived from at least one of said second feature and said second load information.

36. The method of claim 35 wherein the first feature information includes, for each first location identifier, a first range of availability times and the first load information includes for each first location identifier, a first arrival time, the second feature information includes, for each second location identifier, a second range of expected arrival times and the second load information includes, for each second location identifier, a second arrival time and wherein the first time discrepancy information represents an aggregation of differences between the first arrival times and the first ranges of expected arrival times and the second time discrepancy information represents an aggregation of differences between the second arrival times and the second ranges of expected arrival times.

37. The method of claim 35 wherein said first and second derived information include said first and second time discrepancy information respectively.

38. The method of claim 1 wherein:
causing the at least one processor to derive said first derived information comprises causing the at least one processor to generate first summary load information derived from said first load information; and
causing the at least one processor to derive said second derived information comprises causing the at least one processor to generate second summary load information derived from said second load information.

39. The method of claim 38 wherein the first summary load information represents a first aggregation of load weights associated with the first location identifiers and the second summary load information represents a second aggregation of load weights associated with the second location identifiers.

40. The method of claim 38 wherein the first summary load information represents a first aggregation of load volumes associated with the first location identifiers and the second summary load information represents a second aggregation of load volumes associated with the second location identifiers.

41. The method of claim 40 wherein the first summary load information represents the first aggregation of load volumes divided by an aggregation of carrier capacities associated with the first transport routes and wherein the second summary load information represents the second aggregation of load volumes divided by an aggregation of carrier capacities associated with the second transport routes.

42. The method of claim 38 wherein the first summary load information represents a first aggregation of load container quantities associated with the first location identifiers the second summary load information represents a second aggregation of load container quantities associated with the second location identifiers.

43. The method of claim 38 wherein said first summary load information represents a first efficiency derived in part from first carrier capacity information associated with the first transport routes and said second summary load information represents a second efficiency derived in part from second carrier capacity information associated with the second transport routes.

44. The method of claim 38 wherein said first and second derived information include said first and second summary load information respectively.

45.-120. (canceled)

121. An apparatus for facilitating display of information to a user for use in planning transport routes, the apparatus comprising at least one processor configured to:
receive signals representing first transport information representing a first set of proposed first transport routes, each first transport route having one or more first locations associated therewith, wherein said first transport information includes, for each of the first locations, a first location identifier and associated first feature information and first load information, wherein said first transport routes are represented by respective sets of said first location identifiers;
produce signals for causing a display to display a representation of the first transport information;
derive and store in memory first derived information derived from at least one of:
said first location identifiers,
said first feature information, and
said first load information;
receive user input signals representing changes to the first transport information;
generate second transport information representing a second set of proposed second transport routes based on the received user input signals defining said changes to the first transport information, each second transport route having one or more second locations associated therewith, wherein said second transport information includes, for each of the second locations, a second location identifier and associated second feature information and second load information, wherein said second transport routes are represented by respective second sets of said second location identifiers;
produce signals for causing the display to display a representation of the second transport information;
derive second derived information derived from at least one of:
said second location identifiers,
said second feature information, and
said second load information; and
produce signals for causing the display to display a representation comparing the first derived information with the second derived information.

122.-180. (canceled)

181. A non-transitory computer readable medium having stored thereon codes which, when executed by at least one processor, cause the at least one processor to:
receive signals representing first transport information representing a first set of proposed first transport routes, each first transport route having one or more first locations associated therewith, wherein said first transport information includes, for each of the first locations, a first location identifier and associated first feature information and first load information, wherein said first transport routes are represented by respective sets of said first location identifiers;
produce signals for causing a display to display a representation of the first transport information;
derive and store in memory first derived information derived from at least one of:
said first location identifiers,
said first feature information, and
said first load information;
receive user input signals representing changes to the first transport information;
generate second transport information representing a second set of proposed second transport routes based on the received user input signals defining said changes to the first transport information, each second transport route having one or more second locations associated therewith, wherein said second transport information includes, for each of the second locations, a second location identifier and associated second feature information and second load information, wherein said second transport routes are represented by respective second sets of said second location identifiers;
produce signals for causing the display to display a representation of the second transport information;
derive second derived information derived from at least one of:
said second location identifiers,
said second feature information, and
said second load information; and
produce signals for causing the display to display a representation comparing the first derived information with the second derived information.
